(19) United States
(12) Patent Application Publication
(10) Pub. No.: US 2026/0289451 A1
(43) Pub. Date: Sep. 24, 2026

(54) SYSTEM

(71) Applicant: SoftBank Group Corp., Tokyo (JP)

(72) Inventor: Masaomi KAWAAI, Tokyo (JP)

(73) Assignee: SoftBank Group Corp., Tokyo (JP)

(21) Appl. No.: 19/560,303

(22) Filed: Mar. 9, 2026

(30) Foreign Application Priority Data
Mar. 19, 2025 (JP) 2025-044901

(51) Int. Cl. G06Q 10/0631; G06N 3/0475; G06Q 10/0639; G06V 40/20

(52) U.S. Cl. CPC G06Q 10/06313; G06N 3/0475; G06Q 10/06398; G06V 40/20

(57) ABSTRACT

A system includes a processor that is configured to provide an interface for inquiring about a state and a spending plan of a user, generate a prompt for instructing a generative AI model to present one or more optimal options, input the generated prompt to the generative AI model, and present to the user at least one optimal option based on an output from the generative AI model.

### CROSS-REFERENCE TO RELATED APPLICATION

This application is based on and claims priority under 35 USC 119 from Japanese Patent Application No. 2025-044901 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information processing systems that assist a user in making selections, such as product choices, service plans, or menu items, typically rely on fixed rule-based logic or static recommendation lists. Such systems are often unable to flexibly reflect a current state of the user, such as mood, preference, or situational constraints, and a spending plan of the user, such as a budget or desired expenditure range. As a result, the presented options may be inappropriate or suboptimal for the user at that time.

Furthermore, when a user starts using a terminal, the user is sometimes required to perform multiple operations before meaningful options are displayed, for example, navigating through menus and input screens. This leads to a delay until options are presented, and reduces usability and user satisfaction, especially in environments where quick decision-making is desired, such as restaurants, retail stores, or transportation hubs.

In addition, conventional systems often do not make effective use of past data in combination with the current state and spending plan of the user. For example, historical usage data, purchase records, or operational data such as inventory and sales are not fully utilized for generating prompts and recommendations. Consequently, efficient resource utilization, including reduction of waste, optimization of inventory, and alignment with operational constraints, is not sufficiently promoted.

Therefore, there is a need for a system that can inquire about a state and a spending plan of a user via an interface, automatically generate an appropriate prompt for a generative AI model, and, by using the generative AI model, rapidly present optimal options tailored to the user's situation, while also enabling promotion of efficient resource utilization based on past data and operational information.

### SUMMARY

In order to solve the above-described problems, according to one aspect of the present invention, there is provided a system comprising a processor, wherein the processor is configured to provide an interface for inquiring about a state and a spending plan of a user, generate a prompt for instructing a generative AI model to present one or more optimal options, input the generated prompt to the generative AI model, and present to the user at least one optimal option based on an output from the generative AI model. By directly acquiring information regarding the user's current state and spending plan, and by transforming this information into a structured prompt suitable for the generative AI model, the system is able to flexibly produce options that are tailored to the user's context.

In one embodiment, the processor is configured, upon the user taking a seat, to start an information processing device automatically by using a sensor, and to generate a prompt for instructing rapid presentation of one or more options through the interface. By automatically activating the information processing device in response to seat occupancy, and by immediately generating a prompt that requests the generative AI model to provide options, the system can shorten the time from user arrival to display of suitable options, thereby improving usability and user experience.

In another embodiment, the processor is configured to refer to past data in order to present one or more options based on the state and the spending plan of the user by using the generative AI model, and to generate a prompt for instructing promotion of efficient resource utilization. The past data may include, for example, historical user behavior data, purchase history, inventory levels, sales performance, or other operational records. By embedding such past data or its summary into the prompt to the generative AI model, the system causes the generative AI model to output options that are not only suited to the user but also aligned with operational goals, such as reducing waste, balancing inventory, or improving sales of low-performing items. Thus, the system simultaneously enhances personalization for the user and promotes efficient resource utilization on the operator side.

The term “system” refers to an arrangement including at least one processor and, where applicable, one or more associated devices, memories, interfaces, sensors, and networks, which cooperatively execute the functions described in the claims.

The term “processor” refers to any hardware logic circuitry capable of executing instructions, including but not limited to a central processing unit (CPU), a microprocessor, a microcontroller, a digital signal processor (DSP), or a programmable logic device, and may be implemented as a single device or a plurality of devices operating together.

The term “interface” refers to a hardware and/or software mechanism through which a user provides input and receives output, including but not limited to a graphical user interface displayed on a screen, touch input elements, buttons, voice input and output components, or any combination thereof.

The term “state of a user” refers to information indicating a current condition of the user, including but not limited to mood, preference, physical condition, time-related constraints, situational context, or intended purpose of use, as obtained through the interface.

The term “spending plan of a user” refers to information relating to an intended or permissible amount of expenditure by the user, including but not limited to a budget value, a price range, or a constraint on total cost for one or more options.

The term “generative AI model” refers to a machine learning model that generates output content, such as text, images, or structured data, in response to input data or prompts, including but not limited to large language models and other neural network-based generative models.

The term “prompt” refers to data provided as input to the generative AI model, including but not limited to a structured textual instruction, a query, a context description, and parameter information, for causing the generative AI model to generate output corresponding to one or more desired options.

The term “option” refers to any candidate item, action, plan, or recommendation that may be presented to the user for selection, including but not limited to a product, a service, a menu item, a configuration, or a combination thereof.

The term “optimal option” refers to an option that is determined, based on at least the state of the user and the spending plan of the user, to be suitable or preferable for the user according to one or more criteria encoded in or inferred by the generative AI model or the system.

The term “information processing device” refers to a device that executes information processing functions for interaction with the user, including but not limited to a tablet terminal, a kiosk, a personal computer, a smartphone, or a dedicated ordering terminal.

The term “sensor” refers to a device that detects a physical or environmental condition relevant to system operation, including but not limited to a seat occupancy sensor, a proximity sensor, a pressure sensor, or an optical sensor, and that outputs a signal used by the processor to trigger activation or control of the information processing device.

The term “past data” refers to data recorded before a current interaction with the user, including but not limited to historical user behavior logs, purchase histories, inventory records, sales performance data, and operational logs related to resource usage.

The term “resource utilization” refers to the manner in which physical or virtual resources are consumed or allocated, including but not limited to inventory items, products, energy, and service capacities, in connection with providing options or fulfilling user selections.

The term “efficient resource utilization” refers to utilization of resources in a way that meets operational objectives while reducing waste or inefficiency, including but not limited to minimizing unsold inventory, balancing sales across items, or aligning usage with demand patterns.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

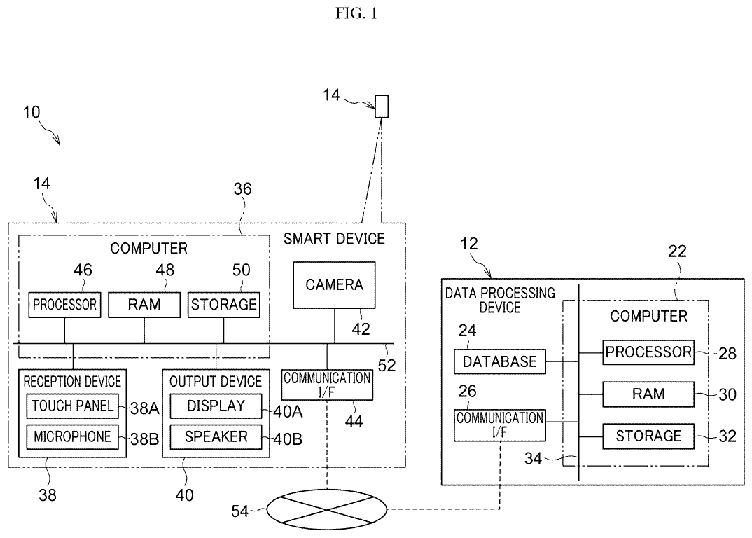

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

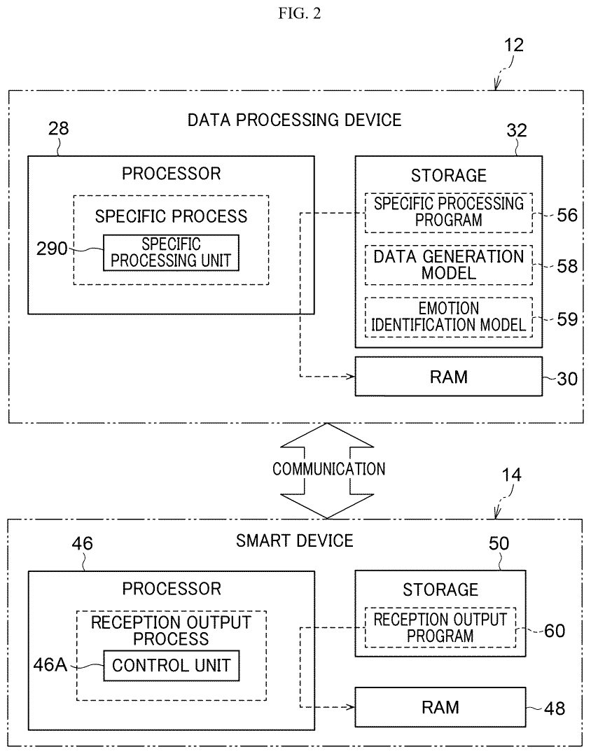

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### EXAMPLE 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented ordering systems in food service environments typically rely on static user interfaces and predetermined decision trees for guiding a user through menu selection. In such systems, a processor of a terminal device simply presents fixed screens and fixed question flows, and receives item selections without flexibly adapting to the user's current state or expenditure plan. As a result, the processor often generates excessive screen transitions, redundant user inputs, and inefficient data exchanges with a back-end server. This causes increased processing overhead, longer interaction times, and degraded usability, especially when menus are large or change dynamically.

Furthermore, in many existing systems, recommendation logic is implemented as a fixed rules engine stored in memory. When a user's preference or budget is non-typical, the processor must traverse multiple rule sets, perform repeated database lookups, and re-render multiple candidate screens. This leads to increased consumption of computing resources on the terminal and the server, as well as increased network traffic between the terminal and the server. In addition, conventional systems do not effectively reuse past order history and response history to streamline later interactions, so the processor repeatedly recomputes similar recommendation patterns without efficiently narrowing the candidate space.

In addition, current systems often treat menu availability or inventory constraints as a separate post-processing step. The processor of the terminal presents recommendations that have been computed without real-time availability information from the external processing device. When the server later detects that certain items are unavailable, the system must invalidate previously displayed recommendations and trigger additional communication and recomputation. This fragmented architecture increases round-trip latency, causes inconsistent displays between the terminal and kitchen systems, and can require the user to restart the selection process, thereby degrading the technical performance of the entire ordering pipeline.

Moreover, known systems that attempt to incorporate machine learning-based recommendation engines typically perform such processing on a central server only, and provide the terminal with generic recommendation results. In such architectures, the terminal processor plays a passive role and cannot flexibly construct or adapt prompt sentences for an intelligent model based on local interaction context, such as the current seat, current session state, and current user responses. As a consequence, both terminal and server processors must handle more interaction steps, more error correction screens, and more confirmation messages, resulting in inefficient utilization of computational resources and network bandwidth.

Accordingly, there is a need for an improved computer-implemented system in which a processor of an information processing apparatus (or server) and a processor of a terminal cooperate to dynamically construct and supply prompt sentences to a generative AI model, obtain context-aware option information tailored to a user's current state and expenditure plan, and continuously update the presented options based on real-time availability information, while effectively reusing past order and response histories. Such a system should reduce redundant processing, minimize unnecessary screen transitions, and improve computational and network efficiency in generating and presenting order options.

The specific processing by the specific processing unit 290 of the data processing device 12 in Example 1 is realized by the following means.

The present invention provides a server comprising a processor, a memory device, a communication interface, and a storage of program instructions, wherein the processor is configured, by executing the program instructions, to: receive, from a terminal device via the communication interface, user preference information and user expenditure plan information that have been acquired through a user interface of the terminal device; acquire item information from the memory device or from an external data source; construct a prompt sentence based on the user preference information, the user expenditure plan information, and the item information; input the prompt sentence and the item information into a generative AI model to obtain option information including a plurality of options corresponding to the user preference information and the user expenditure plan information; transmit the option information to the terminal device via the communication interface; receive, from the terminal device, order information generated based on one or more options selected by the user; acquire availability information or supply information relating to the item information; update the option information based on the availability information or the supply information; and transmit updated option information to the terminal device, wherein the processor is further configured to acquire past order history information and response history information from the memory device and to include the past order history information and the response history information in the prompt sentence so as to cause the generative AI model to generate option information that reflects the histories. This enables a technical improvement of the computer system by allowing the processor to offload complex recommendation logic to the generative AI model through structured prompt sentences, to reduce redundant rule-based processing, to dynamically adapt the generated options to real-time availability and past usage patterns, and to thereby decrease computational load, network traffic, and user interaction steps required to produce context-appropriate order candidates.

The term “processor” refers to a hardware computing element, such as a central processing unit, microcontroller, or other arithmetic and logic unit, that executes program instructions to perform data processing and control operations of the system.

The term “memory device” refers to a hardware storage element, such as a volatile memory or a non-volatile memory, that stores program instructions, configuration data, item information, order history information, response history information, and intermediate data used by the processor.

The term “display device” refers to an output component, such as a liquid crystal display, organic light-emitting diode display, or other visual display unit, that presents graphical or textual information, including prompt sentences and option information, to a user.

The term “input device” refers to an input component, such as a touch panel, keypad, pointing device, or sensor-based control, that receives user operations, including selections of options and entry of preference information and expenditure plan information.

The term “communication device” refers to a hardware communication interface, such as a wired or wireless network interface, that transmits and receives data between the system and an external device or external processing device according to a communication protocol.

The term “detection device” refers to a sensing component, such as a pressure sensor, occupancy sensor, or other presence-detecting unit, that generates a detection signal indicating whether a user is seated or present at a designated location.

The term “information processing device” refers to a computing apparatus, such as a terminal device or server device, that includes a processor and associated components to execute program instructions and perform data processing operations for user interaction and order processing.

The term “user interface” refers to a combination of hardware and software elements, including the display device and the input device, that enables bidirectional interaction between the user and the information processing device.

The term “user preference information” refers to information indicating a user's desired content or conditions, such as desired food type, taste preference, or other selection criteria, that is acquired via the user interface.

The term “user expenditure plan information” refers to information indicating a user's budget or spending constraints, such as a maximum amount of currency or price range, that is acquired via the user interface.

The term “item information” refers to structured data representing available offerings, such as menu items, products, or services, including identifiers, names, attributes, categories, and prices of the offerings.

The term “external device” refers to a device separate from the information processing device, such as a remote database server or management system, that stores or manages item information or related data and communicates with the system via the communication device.

The term “external processing device” refers to a device having a processor and communication interface that receives order information from the system, performs subsequent processing such as inventory management or order routing, and returns availability information or supply information to the system.

The term “prompt sentence” refers to a natural-language text or structured instruction generated by the processor, which is supplied to a generative AI model as input to cause the generative AI model to produce option information responsive to user preference information and user expenditure plan information.

The term “generative AI model” refers to a machine-implemented information processing model, such as a neural network-based language model, that generates text or structured data outputs, including option information, in response to input data such as prompt sentences and item information.

The term “option information” refers to information representing one or more candidate selections or combinations of items, generated by the generative AI model based on the prompt sentence and item information, and corresponding to the user preference information and user expenditure plan information.

The term “order information” refers to structured data generated based on one or more options selected by the user, including identifiers of selected items, quantities, associated prices, and a linkage to a user or seat, which is transmitted to the external processing device.

The term “availability information” refers to data indicating whether particular items or services are currently available, unavailable, or limited, such as stock status or preparation capability, as provided by the external processing device.

The term “supply information” refers to data indicating a supply state or provisioning condition of items or services, including replenishment status, preparation capacity, or time constraints, as provided by the external processing device.

The term “past order history information” refers to stored data representing one or more past orders associated with a user, a seat, or a session, including previously selected items, quantities, times, and other related attributes.

The term “response history information” refers to stored data representing past interaction responses from a user or seat, including previous answers to questions, previous preference inputs, and previous expenditure plan inputs obtained via the user interface.

The term “seat” refers to a user location, such as a chair, booth, or designated position, at which the detection device is provided and to which orders and interactions can be associated.

The term “session” refers to a continuous interaction period associated with a user or seat, beginning, for example, when seating is detected and ending when an order process or interaction process is completed.

In one embodiment, a system includes a server, a plurality of terminals, and one or more external processing devices connected via a communication network. The server includes a processor, a memory device, and a communication interface. Each terminal includes a processor, a memory device, a display device, an input device, a detection device, and a communication device. The external processing device includes a processor, a memory device, a communication interface, and, in some cases, a display or printing device used in a preparation area.

### A. Hardware and Software Configuration

The terminal uses a general-purpose computing platform, such as a tablet computer or embedded information processing device, including a processor (for example, an ARM-based central processing unit), a memory device (for example, dynamic random access memory and non-volatile flash memory), a display device (for example, a liquid crystal display panel with a capacitive touch layer), and a detection device (for example, a pressure sensor or load sensor installed beneath a seat). The terminal executes an operating system such as a mobile operating system or embedded operating system and runs an order application installed in the memory device.

The server uses a general-purpose server platform including a multi-core processor (for example, an x86-based processor), a main memory, and a non-volatile storage device (for example, a solid-state drive). The server executes a server operating system and a server application program that performs management of item information, user history information, and interaction with a generative AI model. The server optionally uses a hardware accelerator such as a graphics processing unit to execute neural network inference and training.

The external processing device may be a kitchen display system, a preparation control system, or a printer controller. The external processing device receives order information from the server and outputs human-readable instructions or printouts to preparation personnel.

### B. Generative AI Model Structure

The server stores, in the memory device, a generative AI model implemented as a neural network, for example a transformer-based sequence-to-sequence language model. The generative AI model includes an embedding layer that converts discrete tokens of text (characters or words) into continuous vector representations, a plurality of self-attention layers, feedforward layers, and an output layer that generates probabilities over a vocabulary of tokens. The server trains the generative AI model on text data representing menu descriptions, ordering dialogs, and historical prompt sentences and responses.

The server uses a loss function such as cross-entropy loss to train the generative AI model. The server minimizes the loss by performing gradient-based optimization, for example using stochastic gradient descent or Adam optimization, and updates the weights of the neural network through backpropagation. The server may perform data augmentation by paraphrasing prompt sentences, randomly masking parts of user preference sentences, and varying budget descriptions, in order to enhance robustness to varied user inputs.

The server configures the generative AI model to accept a prompt sentence that includes structured instructions and contextual information, and to output text or structured option descriptions. The server can also quantize the trained model parameters (for example, 8-bit or 4-bit quantization) and deploy an inference-only version on the terminal when local execution is required, using a neural network runtime such as a device-side inference engine.

### C. Data Structures and Storage

The server stores item information in a relational database or key-value store. The item information includes fields such as item identifier, item name, category, price, dietary attributes, and availability flags. The server stores past order history information and response history information indexed by user identifier or seat identifier. Each history record includes a timestamp, list of ordered item identifiers, total amount, and key responses provided by the user, such as frequent preferences or budget ranges.

The terminal stores, in its local memory, a subset of item information synchronized from the server, as well as configuration information necessary to construct prompt sentences. The terminal uses internal data structures such as objects or records containing user preference information, user expenditure plan information, and a list of candidate option information. The terminal converts these data structures into serialized formats (for example, textual lines with delimiters) for inclusion within prompt sentences supplied to the generative AI model.

### D. Prompt Sentence Generation and Interaction

The terminal generates a prompt sentence for the generative AI model by combining multiple elements. The terminal retrieves user preference information and user expenditure plan information that the user inputs via the input device. The terminal further retrieves local item information or requests item information from the server via the communication device. The terminal then constructs a natural-language instruction that includes:
(1) A role description of the generative AI model.
(2) A description of the current user input (preference and budget).
(3) A specification of the output format and constraints (for example, number of options, budget limit, type of dishes).

For example, the terminal constructs a prompt sentence such as:

“You are an AI assistant for a restaurant that offers a variety of dishes, including sushi. The customer has described what they feel like eating and their budget. Based on the following information, propose several specific menu options that match the customer's preference and stay within the budget.

Customer input: ‘I want to eat sushi today. My budget is 2000 yen.’

Task: Recommend 3 concrete menu options under 2000 yen, and explain briefly why each option is suitable for the customer.”

In another use case, the terminal constructs a prompt sentence including history information retrieved from the server:

“You are an AI assistant for a restaurant. The customer has previously ordered several items and has certain recurring preferences. Use the customer's past order history to avoid redundant suggestions and to propose complementary items.

Customer's past orders: salmon sushi, tuna sushi, egg sushi.

Current input: ‘I want something light and my budget is 800 yen.’

Task: Recommend 2 side dishes that fit within 800 yen and go well with the past orders.”

The server, in some embodiments, generates or refines prompt sentences on the server side. The server acquires user preference information, user expenditure plan information, item information, and history information, and synthesizes a prompt sentence according to predefined templates and optimization logic. The server then passes the prompt sentence to the generative AI model and obtains option information.

### E. Cooperation Between Server and Terminal

The terminal actively constructs context-specific prompt sentences rather than relying on static question sequences. The terminal includes seat identification, session identification, and recent interaction context in the prompt sentences. This enables the generative AI model to generate option information that is immediately usable by the terminal without requiring multiple additional clarification steps.

The server receives user preference information, user expenditure plan information, and interaction context from the terminal. The server merges this information with item information and history stored in the server's memory device. The server constructs a combined input sequence for the generative AI model in which special tokens or markers delimit sections, such as system instruction, user input, menu summary, and history summary. This structured sequence allows the generative AI model to attend selectively to specific parts of the input, thereby improving relevance and reducing the number of tokens needed, which in turn reduces processing time and memory consumption.

The server, after receiving option information from the generative AI model, filters and annotates the options based on real-time availability information obtained from the external processing device. The server modifies or removes options whose items are not currently available and generates a final option set for transmission to the terminal. This step avoids repeated re-inference caused by unavailability, and reduces the number of communication cycles between the server and terminal.

### F. Technical Improvements and Non-conventional Processing

The server, by using a transformer-based generative AI model with structured prompt sentences, avoids large rule-based decision trees that would otherwise require many conditional branches and frequent database lookups. Instead of computing recommendations through nested rules for each interaction, the server presents a condensed, semantically rich context to the generative AI model. This reduces program complexity and processor branch mispredictions, and leads to improved cache utilization during execution.

The server also reduces communication payload size by embedding relevant item information in summarized natural-language or abbreviated form within the prompt sentence, rather than sending entire large tables repeatedly. The server can precompute compact summaries of menu categories and price ranges, which are then referenced in prompt sentences. This approach reduces network bandwidth usage and lowers latency for generating recommendations.

The terminal, by detecting seating via the detection device and automatically activating the information processing device, reduces idle processing and screen rendering. The terminal keeps the processor in a low-power state until seating is detected. After seating, the terminal immediately presents a context-aware prompt sentence, thereby reducing the number of manual operations and screen transitions required to reach a recommendation screen. This yields lower CPU utilization and shorter interaction time per session compared to conventional static menus.

The generative AI model uses internal attention weights to learn correlations between budget expressions, item categories, and user preference phrases. The server leverages these learned correlations so that small changes in user phrasing do not require new hand-crafted rules. This improves accuracy of options and reduces errors in budget matching (for example, options exceeding the budget) because the generative AI model is trained to penalize outputs that violate explicit budget constraints included in the prompt sentence.

The server periodically retrains or fine-tunes the generative AI model based on collected interaction logs. The server uses the mismatch between suggested options and actually selected items as implicit feedback. The server defines a custom loss term that increases when the generative AI model proposes items that are consistently not selected and decreases when proposed items are frequently selected. This adaptive optimization improves the relevance of generated options over time without manual rule updates. As the model becomes more accurate, the number of subsequent clarification screens is reduced, which further lowers processing load on both the server and terminal.

### G. Alternative Embodiments and Variations

In some embodiments, the terminal executes a local instance of the generative AI model. The terminal stores a quantized version of the model in the local memory device and uses a device-side inference engine to perform generation. The terminal still constructs prompt sentences as described above but does not transmit them to the server for inference. This reduces network usage and permits operation in environments with limited connectivity. The server in such a configuration focuses on maintaining up-to-date item information and history, synchronizing them periodically to the terminals.

In other embodiments, the server separates the generative AI model into a context encoder and a decoder. The server or terminal first encodes user preference information, user expenditure plan information, and history information into vector representations, using a context encoder model. The server then combines these vectors with item information representations to perform decoding and generate options. This modular architecture allows caching of encoder outputs for repeated users or repeated seats, which reduces inference time and improves responsiveness.

In yet another embodiment, the server uses specific feature extraction rules to annotate item information with technical attributes, such as caloric content, preparation time, and ingredient categories. The server includes these attributes in the prompt sentence or as embedded tags. The generative AI model is thus able to generate options that also optimize for system-side constraints (for example, balanced kitchen load or reduced preparation time) in addition to user-side constraints. This non-human-centric optimization shows that the AI processing is not merely an automation of human judgment, but a technical optimization across multiple system resources.

### H. Use Case and Concrete Example

The terminal detects that the user has taken a seat via the detection device. The terminal activates the screen and displays a first greeting. The terminal then constructs a prompt sentence:

“What would you like to eat today?”

“What is your budget today?”

The user inputs “I want to eat sushi today.” and “My budget is 2000 yen.” via the touch panel. The terminal sends these inputs, together with seat identification, to the server. The server retrieves relevant item information and past history for that seat, constructs a detailed prompt sentence such as:

“You are an AI assistant for a restaurant that offers various sushi plates. The customer said: ‘I want to eat sushi today. My budget is 2000 yen.’ The available menu items include multiple types of sushi with different prices. Please propose 3 menu options, each under 2000 yen, that combine different sushi types and are easy to understand for the customer. For each option, describe the included items and the total price, and briefly explain why this option is a good choice.”

The server inputs this prompt sentence and menu information to the generative AI model, obtains three candidate options with descriptions, filters them based on current availability, and returns them to the terminal. The terminal displays the options on the display device as selectable cards. The user selects one option via the input device. The terminal generates order information and sends it to the external processing device (for example, a preparation system) via the server. The external processing device displays the order content for preparation.

Through these concrete configurations and operations, the server and terminal implement a system in which the generative AI model and prompt sentences are integrated into a technical architecture that improves processing speed, interaction efficiency, and resource utilization, beyond simple automation of human decision-making.

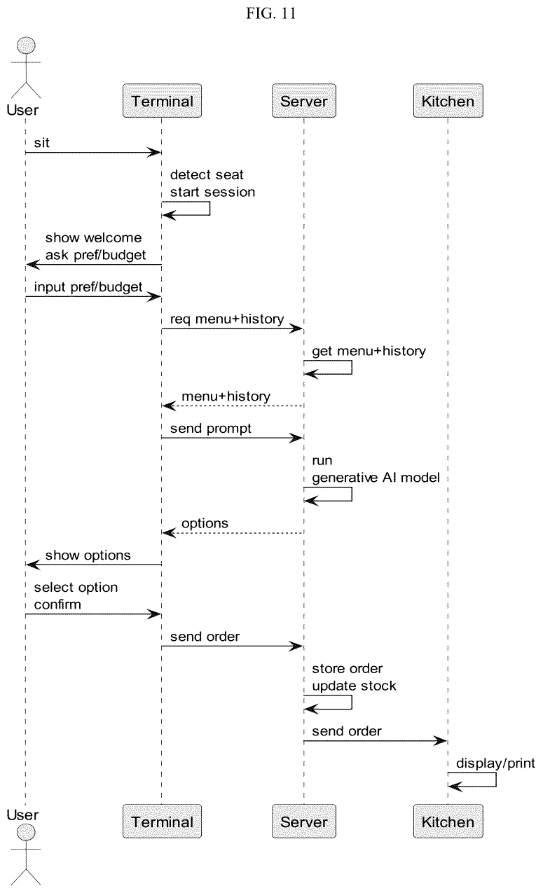

The following describes the processing flow using FIG. 11.

### Step 1:

Terminal receives a detection signal from the detection device mounted on a seat.

Terminal uses an analog-to-digital converter or a digital input interface to read a sensor value and compares the sensor value against a stored threshold value and a debounce time.

Input: raw sensor signal indicating a pressure level or occupancy state.

Processing: Terminal samples the signal at fixed intervals, averages several samples to reduce noise, compares the averaged value with the threshold, and determines whether the user is seated by evaluating whether the threshold is exceeded continuously for a predetermined period.

Output: a binary seating status flag and a seat identifier used as context for subsequent processing.

Terminal, upon detecting a seated state, activates the display device, wakes the processor from a low-power mode, and launches an order application process.

### Step 2:

Terminal initializes a session associated with the seat.

Terminal generates a new session identifier, associates the session identifier with the seat identifier, and stores this association in local memory.

Input: seating status flag and seat identifier from Step 1.

Processing: Terminal increments a session counter or generates a random session token, records a timestamp, and allocates in-memory data structures for storing user preference information, user expenditure plan information, and subsequent option information.

Output: a session context object containing the seat identifier, session identifier, and initial timestamp.

Terminal displays a welcome message and basic instructions on the display device.

### Step 3:

Terminal prompts the user to enter preference information and expenditure plan information.

Terminal displays one or more questions on the display device, such as “What would you like to eat today?” and “What is your budget today?”, and provides input fields and virtual keyboard controls.

Input: session context object from Step 2.

Processing: Terminal renders user interface components, binds the components to internal variables for preference text and budget value, and waits for user interactions.

Output: a user interface state that is ready to receive text and numeric input.

### Step 4:

User inputs preference information and expenditure plan information via the input device.

User touches the display device to activate a text field, types a natural-language statement such as “I want to eat sushi today.” and enters a numeric budget such as “2000 yen.”

Input: visual questions and input fields presented by the terminal in Step 3.

Processing: User manually selects characters on the virtual keyboard, confirms numeric entries, and optionally edits or corrects previously entered text.

Output: raw input events, including touch coordinates, keypress identifiers, and confirmation actions, which are sent to the terminal's input subsystem.

### Step 5:

Terminal converts the raw input events into structured preference and budget data.

Terminal collects all touch events, maps them to characters and control keys, and builds text strings for the preference sentence and expenditure plan expression.

Input: raw input events from Step 4.

Processing: Terminal decodes keypress sequences into Unicode strings, parses numeric values from the budget input, normalizes currency notation, and stores the results in the session context object. Terminal may also perform basic natural-language preprocessing, such as trimming whitespace and detecting language.

Output: user preference text, user budget value, and an updated session context object that includes these values.

### Step 6:

Server provides item information and optional history information to support recommendation generation.

Server receives a request from the terminal containing the seat identifier, session identifier, and a request for current item information and history.

Input: request message from the terminal including seat identifier and session identifier.

Processing: Server queries a database to retrieve item records (item identifiers, names, categories, and prices) and retrieves past order history information and response history information associated with the seat identifier or a linked user identifier. Server may filter items based on time-of-day or availability flags.

Output: a response message containing a curated list of item information and, optionally, summarized history entries, transmitted to the terminal via the communication interface.

### Step 7:

Terminal constructs a prompt sentence for a generative AI model using preference, budget, item information, and optional history.

Input: user preference text and budget value from Step 5, and item information and history information from Step 6.

Processing: Terminal concatenates these data elements into a structured natural-language prompt sentence and may embed markers that distinguish instruction parts, user input, and menu summaries. Terminal can also apply templates that describe model behavior, such as “You are an AI assistant for a restaurant . . . ” and specify constraints such as “Recommend 3 options under the specified budget.”

Output: a complete prompt sentence instructing the generative AI model how to generate option information for the current session.

### Step 8:

Server or terminal supplies the prompt sentence and item information to the generative AI model and obtains option information.

When the model is server-side, server receives the prompt sentence and item information from the terminal and forwards them to a generative AI model engine implemented as a transformer-based language model.

Input: prompt sentence and item information from Step 7.

Processing: Server tokenizes the prompt sentence and encodes the tokens into embeddings, processes them through multiple self-attention layers and feedforward layers, and computes a probability distribution over possible output tokens at each generation step. Server generates candidate options by sampling or using beam search under constraints that reflect the budget and item list. The server decodes the generated tokens into natural-language descriptions of recommended options and, optionally, structured markers that identify item identifiers and total prices.

Output: option information that includes multiple recommended combinations of items, associated total prices, and textual explanations for each option, returned to the terminal.

### Step 9:

Terminal presents the option information to the user via the display device.

Terminal parses the option information into internal data structures, associates each option with a list of item identifiers and prices, and generates graphical presentation components such as cards or lists.

Input: option information from Step 8.

Processing: Terminal maps item identifiers to display names and images, sorts options by price or relevance if needed, and allocates display regions for each option. Terminal may also compute and display additional derived data, such as total calories or the number of items per option.

Output: a rendered screen showing multiple selectable options, each with a description, total price, and a short explanatory sentence.

### Step 10:

User selects one or more options and confirms an order.

User touches an option presented on the display device and optionally adjusts quantities or adds supplementary items. User then activates a confirmation control, such as a “Confirm order” button.

Input: list of presented options and interactive controls from Step 9.

Processing: User physically interacts with the display device to indicate a selection, review the summary, and finalize the decision.

Output: selection events specifying which options have been chosen, including item sets and quantities, sent to the terminal's input subsystem.

### Step 11:

Terminal generates order information from the selected options and transmits it to the server.

Terminal reads the selected option identifiers and associated item identifiers, computes the total price, and constructs a structured order record.

Input: selection events from Step 10 and option information from Step 8.

Processing: Terminal aggregates the items, resolves duplicate items by increasing quantities, recalculates totals, and validates that required fields (seat identifier, session identifier, item list, quantities, and total price) are present. Terminal then serializes this order record into a message for transmission.

Output: an order information message containing item identifiers, quantities, total price, seat identifier, and session identifier, transmitted to the server via the communication device.

### Step 12:

Server processes the order information and forwards it to the external processing device.

Server receives the order information from the terminal, stores it in a database, and generates a format suitable for a kitchen display or printer.

Input: order information from Step 11.

Processing: Server validates item identifiers against the current item table, checks availability flags, and may update inventory counts. Server then converts the order into a compact message including item codes, quantities, and preparation instructions, and transmits this message to the external processing device using a predetermined protocol.

Output: a kitchen or preparation order message that instructs the external processing device to display or print the ordered items.

### Step 13:

Server updates availability information and adjusts future option information.

Server analyzes the newly received order information to update availability data, such as decrementing stock counts or marking items as temporarily unavailable.

Input: order information from Step 11 and current availability data from storage.

Processing: Server performs arithmetic operations on stock quantities, compares remaining stock against thresholds, and sets availability flags. Server also logs the order as part of past order history, associating it with the seat identifier or user identifier.

Output: updated availability information and extended history data used in subsequent sessions or in retraining of the generative AI model.

### Step 14:

Terminal or server optionally generates further prompt sentences for additional recommendations based on remaining budget or preferences.

Input: updated availability information from Step 13, current session context, and any remaining budget derived from the user's original expenditure plan.

Processing: Terminal or server computes a remaining budget value by subtracting the ordered total from the original budget. Based on this remaining budget and updated availability, terminal or server constructs a new prompt sentence, such as asking the generative AI model to suggest side dishes that fit within the remaining budget and respect item availability constraints.

Output: a refined prompt sentence that takes into account previous choices and updated availability, which is supplied to the generative AI model in a manner similar to Step 8 for generating incremental option information.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented recommendation and ordering systems typically rely on static rule-based logic or simple filtering of pre-defined options. Such systems are not configured to dynamically integrate heterogeneous operational data, such as real-time inventory information and transaction history information, with fine-grained user information, such as a current condition of the user and a spending plan of the user. As a result, existing systems often generate recommendations that do not sufficiently reflect current resource availability or individual user needs, which leads to suboptimal utilization of computational and storage resources, increased processing latency due to repeated ad hoc server-side calculations, and inefficient use of physical resources, including inventory waste.

In addition, in many deployed architectures, a server must perform multiple separate processing flows for user state acquisition, recommendation computation, order generation, and inventory update. These flows are often loosely coupled and implemented as independent modules or services. This fragmented design causes redundant data transfers between components, repeated accesses to storage units, and multiple rounds of data normalization, thereby increasing network load and computational overhead. Consequently, responsiveness of the user interface is degraded, server-side resource utilization is inefficient, and scalability of the overall system is limited.

Furthermore, known systems that incorporate machine learning or artificial intelligence techniques generally use a generative model as a peripheral component, with prompts constructed in an ad hoc manner. The prompts typically do not encode explicit directives regarding inventory constraints, disposal risks, or spending plans. Therefore, the output of the generative model must be heavily post-processed or discarded, which requires additional server-side logic and increases overall processing time. In some cases, the generative model produces infeasible candidate options that cannot be fulfilled due to lack of inventory, leading to increased user interactions and server processing cycles to correct such proposals.

There is thus a need for an improved computer-implemented technique in which a processor centrally orchestrates detection of a user seating state, acquisition of user information, acquisition and management of resource inventory information and transaction history information, generation of structured prompt sentences for a generative AI model, analysis of response information from the generative AI model, and generation of order information. Such a technique should reduce redundant data processing, constrain the generative AI model with system-level directives encoded in a prompt sentence, and ensure that candidate information output to a user terminal conforms to both resource constraints and a user's spending plan. By integrating these functions into a unified processing flow controlled by a processor, it becomes possible to improve the efficiency, reliability, and scalability of the underlying computer system itself.

The specific processing by the specific processing unit 290 of the data processing device 12 in Application Example 1 is realized by the following means.

The present invention provides a server comprising a processor configured to detect a seating state of a user by using a detection unit, to acquire user information including a condition of the user and a spending plan of the user by using a user information acquisition unit, to acquire resource inventory information and transaction history information from a storage unit, to generate a prompt sentence to be input to a generative AI model on the basis of the user information, the resource inventory information, and the transaction history information by using a prompt generation unit, to input the prompt sentence to the generative AI model and receive response information from the generative AI model, to analyze the response information to generate candidate information by using a candidate generation unit, to transmit the candidate information to a user information terminal and control the user information terminal to display the candidate information and to accept a selection operation by using a presentation control unit, and to acquire a selection result from the user information terminal, generate order information on the basis of the selection result, and update the resource inventory information in accordance with the order information by using a resource management unit. This enables a unified and constrained interaction between the server and the generative AI model in which prompt sentences explicitly encode inventory and spending constraints, reduces redundant server-side processing and data transfer, ensures that generated candidate information conforms to real-time resource availability and user-specific parameters, and thereby improves computational efficiency, responsiveness, and resource utilization of the overall computer system.

The term “processor” refers to a hardware processing element, such as a central processing unit or other computing circuitry, configured to execute instructions and control operations of the system.

The term “detection unit” refers to a functional component, implemented by hardware, software, or a combination thereof, that acquires information indicative of whether a user is present or seated, for example by using a sensor or input signal, and outputs a seating state.

The term “seating state” refers to information indicating whether a user is occupying a predetermined position, such as a seat or area associated with a terminal or information processing apparatus.

The term “user information acquisition unit” refers to a functional component, implemented by hardware, software, or a combination thereof, that obtains information related to a user, including at least a condition of the user and a spending plan of the user, through an input interface or communication.

The term “condition of the user” refers to information representing a current preference, mood, desire, or situational state of the user relevant to generation of candidate information.

The term “spending plan of the user” refers to information representing a monetary constraint, budget, or intended expenditure range specified by the user.

The term “storage unit” refers to a memory device, such as a main memory, auxiliary memory, or database system, that stores data including resource inventory information and transaction history information.

The term “resource inventory information” refers to data representing availability, quantity, or status of resources, such as goods, items, or services, that may be proposed or ordered.

The term “transaction history information” refers to data representing past interactions, such as orders, sales, or selections, associated with resources or users over time.

The term “prompt sentence” refers to a text string or structured textual content that is provided as input to a generative AI model to cause the generative AI model to generate response information.

The term “prompt generation unit” refers to a functional component, implemented by hardware, software, or a combination thereof, that constructs the prompt sentence on the basis of user information, resource inventory information, transaction history information, or control policies.

The term “generative AI model” refers to a machine-learned model that generates output content, including text or structured data, in response to input text, such as the prompt sentence.

The term “response information” refers to data output by the generative AI model in response to the prompt sentence and representing proposed content, such as candidate options.

The term “candidate information” refers to data generated on the basis of the response information and representing one or more options or proposals that may be presented to the user.

The term “candidate generation unit” refers to a functional component, implemented by hardware, software, or a combination thereof, that analyzes the response information received from the generative AI model and generates the candidate information.

The term “user information terminal” refers to an electronic device associated with the user, such as a fixed terminal or mobile terminal, that is capable of receiving, displaying, and transmitting information.

The term “presentation control unit” refers to a functional component, implemented by hardware, software, or a combination thereof, that controls transmission of candidate information to the user information terminal and controls display and input operations on the user information terminal.

The term “selection operation” refers to an input action performed by the user, through the user information terminal, to choose or specify at least part of the candidate information.

The term “selection result” refers to data indicating an outcome of the selection operation, including identification of selected candidates and associated parameters.

The term “order information” refers to data generated on the basis of the selection result and representing a finalized request for provision of resources.

The term “resource management unit” refers to a functional component, implemented by hardware, software, or a combination thereof, that manages resource inventory information, including updating the resource inventory information in accordance with the order information.

In one embodiment, a server, one or more terminals, and a user cooperate to implement the claimed system. The server includes at least one processor, a main memory, a non-volatile storage device, and a communication interface coupled via a bus. The server executes a server application on an operating system, such as a UNIX-like operating system, and communicates with the terminals through a packet-switched network using a transport protocol, such as TCP/IP over Ethernet or wireless LAN. The terminals include a fixed terminal installed at a seat and a mobile terminal held by the user. Each terminal includes a display device, an input device such as a touch panel, and a communication interface.

The server stores resource inventory information and transaction history information in a database system, such as a relational database executing on the storage device. The server stores the inventory information in a table structure that includes, for each resource, a resource identifier, a current quantity, a threshold quantity, and one or more attributes such as category and unit cost. The server stores the transaction history information in a table structure that includes, for each transaction, a transaction identifier, one or more resource identifiers, corresponding quantities, timestamps, and associated user or seat identifiers. By structuring the data in this manner, the server can retrieve inventory and transaction history information using indexed queries, which reduces input/output operations and improves retrieval latency compared to unstructured storage.

The terminal installed at a seat includes a detection mechanism that functions as a detection unit. The terminal uses a seat sensor, such as a pressure sensor, infrared sensor, or occupancy switch, to detect whether the user is seated. When the user sits down, the terminal detects a change in an electrical signal from the sensor and generates a seating state signal. The terminal transmits the seating state signal to the server via the communication interface. By offloading the detection to the terminal and using a compact binary representation for the seating state, the system reduces the amount of periodic polling traffic that the server must handle and thereby reduces communication load.

The server uses the processor to receive the seating state signal and to identify the corresponding seat identifier. The server controls a user information acquisition unit implemented as a software module in the server application to cause the terminal to display an input interface for the user. The input interface is described in a markup language and includes form elements to receive the condition of the user and the spending plan of the user. The server transmits the interface description to the terminal, and the terminal renders the description on the display, allowing the user to input text or select options.

The user operates the terminal to input the condition of the user, such as “I want a light meal,” and to input the spending plan, such as a maximum budget value. The terminal captures the user's input through the touch panel and generates a user information message that includes the condition and the spending plan. The terminal transmits the user information message to the server. Because the server defines a compact message format with normalized field names and constraint checks, the terminal can perform local validation before transmission, which reduces invalid or incomplete messages and improves processing efficiency at the server.

The server uses the processor to receive the user information message from the terminal and to store the condition and the spending plan in the database system in association with the seat identifier and a timestamp. The server ensures that the condition is stored as text in a normalized character encoding and that the spending plan is stored as a numeric value, which allows efficient later retrieval and aggregation. The server then retrieves the current resource inventory information and the recent transaction history information from the database system. The server uses query predicates that filter out resources whose quantity is below a threshold and whose expiration date has passed, and it uses aggregate functions on the transaction history to compute sales frequency for each resource over a target period.

The server constructs a prompt sentence by using a prompt generation unit implemented as a software component that has access to the user information, the resource inventory information, and the transaction history information. The server transforms the inventory and transaction data into a summarized textual representation that encodes, for each resource category, whether the stock is high, normal, or low, and whether the sales frequency is high, normal, or low. The server then composes a prompt sentence that concatenates the user condition, the spending plan, and the summarized data together with explicit directives that constrain the generative AI model.

In one concrete example, the server uses the processor to generate the following prompt sentence:

“You are a recommendation engine for a restaurant.

User mood: wants a light meal.

User budget: 2000 yen.

Inventory status: many salads, some grilled chicken, limited steak, surplus vegetable soup.

Goal: Increase user satisfaction and reduce food waste by promoting items with high stock and low recent sales.

Task: Based on the mood, budget, and inventory status, propose 3 to 5 specific menu items that are actually available. For each item, output the name, a short description of 1 to 2 sentences, and a price in yen such that a typical selection of 1 to 2 items stays within the user budget. Return only the proposals, without additional commentary.”

The server provides the prompt sentence to a generative AI model that is stored on the storage device or accessible through a communication network. In one embodiment, the generative AI model is a transformer-based neural network trained for language generation. The server stores model parameters that include multiple layers of self-attention and feed-forward sublayers, token embedding matrices, positional encodings, and output projection matrices. The server stores the model in a compressed format and loads portions of the model into memory on demand to reduce memory footprint and accelerate inference. The server applies an inference algorithm that processes the prompt sentence token by token, computes attention scores, aggregates contextual representations, and predicts subsequent tokens according to a probability distribution over a vocabulary.

During training, the generative AI model is trained using a corpus of text that includes menu descriptions, resource descriptions, and dialog data. The server, or another training apparatus, uses an objective function such as cross-entropy loss between predicted token distributions and true tokens, and updates model weights by backpropagation and a gradient-based optimizer. The server can employ techniques such as mini-batch training, gradient clipping, learning rate schedules, and regularization. The server can also use fine-tuning with domain-specific training data that includes examples of inventory-aware recommendations to reduce prediction error in the target domain and to improve accuracy in proposing feasible resource combinations.

The server configures the generative AI model with inference parameters such as a temperature value, a maximum output length, and a decoding strategy, such as top-k sampling or nucleus sampling. The server selects these parameters to balance diversity and stability of the generated proposals. For example, a moderate temperature and a bounded maximum length reduce the probability of producing excessively long or irrelevant output, which lowers post-processing cost on the server.

When the server provides the prompt sentence to the generative AI model, the server receives response information as a sequence of tokens that form text proposals. The server uses a candidate generation unit to convert the response information into candidate information. The candidate generation unit is implemented as a software module that scans the text output, identifies item names, descriptions, and prices using pattern recognition and delimiter rules, and constructs a structured internal representation such as a list of candidate records. Each record includes fields for a resource identifier (if matched to a resource in the inventory), a candidate name, a description, an offered price, and one or more suitability scores.

The server calculates the suitability scores based on multiple factors, including alignment with the user's condition, alignment with the spending plan, stock surplus level, and sales frequency. The server uses a weighted scoring function that assigns higher scores to resources with higher stock and lower recent sales, and also ensures that the total expected price of typical combinations of candidates does not exceed the spending plan by more than a predetermined tolerance. The server then filters out candidates whose corresponding resource quantity is below the threshold or whose price would violate the spending plan beyond the tolerance, and it sorts the remaining candidates by the suitability scores. In this manner, the server corrects or prunes any infeasible output from the generative AI model and provides only technically viable candidate information to the terminal.

The server uses a presentation control unit to transmit the candidate information to the user information terminal. The server converts the structured candidate information into a format suitable for the display logic of the terminal and attaches metadata such as seat identifier and a recommendation group identifier. The server sends the candidate information over a persistent connection or via a request-response protocol. The terminal receives the candidate information and updates the user interface to show a set of candidate options, each with the name, description, and price. The terminal allows the user to select one or more of the candidates by touching the corresponding display regions. The terminal records the selection in a local data structure and provides visual feedback to the user.

The user interacts with the terminal to finalize a selection result, and the terminal transmits the selection result to the server. The server receives the selection result and uses the processor to generate order information. The order information includes a mapping from the selected candidate identifiers to resource identifiers, quantities, and associated user or seat identifiers. The server writes the order information into the transaction history table in the database system and generates control messages for peripheral equipment, such as display devices in a preparation area or devices that represent a production station. The server then updates the resource inventory information by decrementing the quantities of the resources involved in the order. The server uses atomic database operations or transactional mechanisms to ensure that inventory updates are consistent even if multiple orders are processed concurrently, which improves integrity and prevents over-allocation of resources.

By encoding inventory status, disposal risk, and spending constraints directly into the prompt sentence and by structuring the post-processing of the generative AI model's response around explicit suitability scores and threshold checks, the server reduces the amount of iterative back-and-forth query processing that would otherwise be required with a more naïve integration of a language model. This architectural design reduces the number of network round-trips between the server and any external inference service, reduces redundant database accesses required to correct infeasible recommendations, and decreases latency in presenting acceptable candidates to the user. As a result, system responsiveness is improved, and communication load between components is reduced.

In addition, the server improves computational efficiency by using precomputed aggregate values for transaction history and by compactly summarizing inventory levels into categorical descriptors that are embedded into the prompt sentence. This reduces the dimensionality of the context that the generative AI model must process compared to providing raw tables, leading to faster inference and lower memory usage in the model, which is a technical improvement in the use of the generative AI model for constrained recommendation tasks.

The server further improves accuracy and reduces error in candidate proposals by combining the generative output with deterministic, rule-based filtering. Traditional human-based recommendation practices or simple rule-based systems do not use a generative AI model to explore a large space of potential combinations while simultaneously enforcing dynamic constraints derived from inventory and transaction data. In contrast, the server uses a two-stage process: first, a generative stage that proposes candidate content in an expressive language space, and second, a constraint-enforcing stage that filters and scores the proposals based on internal data structures. This non-conventional combination reduces the rate of infeasible recommendations while preserving flexibility and diversity of proposals, thereby improving overall recommendation quality and reducing the need for manual intervention.

In another embodiment, the server uses a variant of the generative AI model that incorporates specialized tokens or embeddings corresponding to resource categories or budget ranges. The server encodes these tokens in the prompt sentence to provide the model with structured knowledge about the application domain. The server trains or fine-tunes the model using training examples in which such tokens are correlated with specific recommendation outcomes. This structure modifies the internal representation learned by the model so that it can more directly capture budget and inventory constraints at the representation level, further enhancing inference efficiency and precision.

In still another embodiment, the server uses an alternative architecture in which the generative AI model is deployed locally on dedicated accelerator hardware, such as a graphics processing unit or a tensor processing unit, within the server. In this case, the server schedules inference tasks for the generative AI model using a batch scheduler that groups multiple prompt sentences for parallel processing. By batching requests and exploiting parallel computation on the accelerator hardware, the server reduces per-request latency and improves throughput. The server can dynamically adjust the batch size based on current load, using feedback on queue length and response times, thus optimizing use of the hardware resources.

The terminal architecture can also vary. In one configuration, the fixed terminal and the mobile terminal are separate devices; in another configuration, a single mobile terminal acts as the user information terminal and also initiates seating detection through network-based authentication rather than a physical sensor. In either case, the server maintains the same processing flow, using detection information to trigger acquisition of user information, construction of the prompt sentence, invocation of the generative AI model, generation of candidate information, presentation of candidates, acquisition of selection results, and updating of inventory. This flexibility demonstrates that the claimed system is not tied to a particular user interface design but rather to specific internal data structures and processing mechanisms at the server that achieve the technical benefits.

Because the server implements the detection unit, user information acquisition unit, prompt generation unit, candidate generation unit, presentation control unit, and resource management unit as interrelated modules that exchange structured data through defined interfaces, the system reduces redundancy and synchronization errors that may arise in more fragmented architectures. The consistent use of normalized representations for user information, inventory information, transaction history information, prompt sentences, response information, and candidate information enables efficient indexing, caching, and incremental updates. This improves scalability when the number of users, resources, and transactions increases, and contributes to improved overall performance and reliability of the computer system.

Through these configurations, the server, the terminals, and the user cooperate in a way that goes beyond a mere automation of human decision-making. The system restructures the internal data flow, uses specialized prompt sentence construction with embedded operational constraints, and implements a hybrid generative and rule-based algorithm to reduce computational and communication overhead while increasing the technical fidelity of the recommendations. As a result, the invention provides a concrete improvement in computer technology by enhancing the way a computing system integrates a generative AI model with operational data and user interactions.

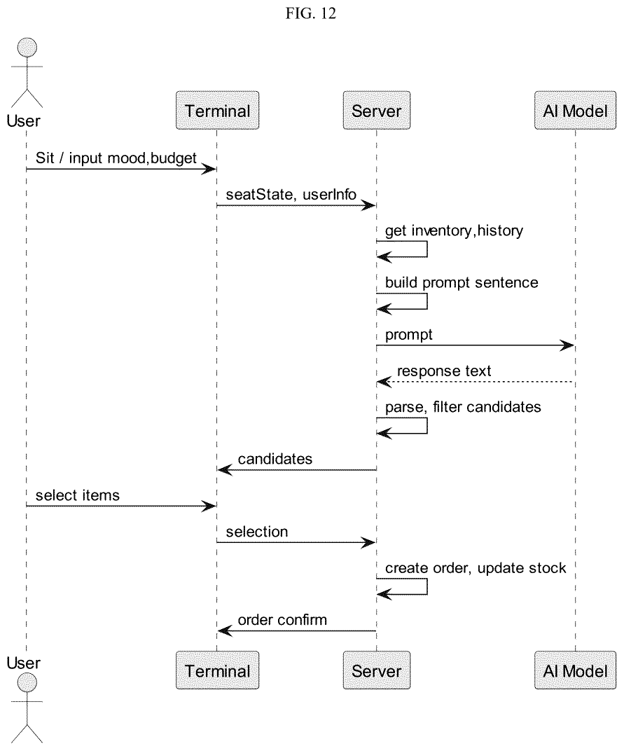

The following describes the processing flow using FIG. 12.

### Step 1:

The terminal detects that the user is seated and notifies the server.

The terminal uses a sensor signal (for example, a change in voltage from a pressure sensor) as input and converts this signal into a digital seating state value (for example, “occupied” or “vacant”). The terminal performs threshold comparison on the sensor value and debouncing logic to avoid false triggers. The output of this processing is a seating state message that includes at least a terminal identifier and a seating state flag. The terminal transmits this seating state message to the server via a communication interface.

### Step 2:

The server receives the seating state message and initiates user interface preparation.

The server uses, as input, the seating state message from the terminal. The server parses the message, verifies the terminal identifier, and checks that the seating state corresponds to “occupied.” Based on this input, the server computes a mapping from the terminal identifier to a seat identifier by referencing a configuration table in a database. The output of this processing is a control instruction that specifies the seat identifier and requires the terminal to display a user input interface. The server generates a screen description (for example, layout parameters and text strings for condition and spending plan input) and sends it to the terminal as an interface definition message.

### Step 3:

The terminal displays the user input interface and acquires user information.

The terminal uses, as input, the interface definition message from the server. The terminal parses layout information and text labels and renders input controls for the user condition and spending plan on the display. The user then touches the display to input text representing the user condition (for example, “I want a light meal”) and to input a numeric value representing a spending plan (for example, “2000”). The terminal performs local validation, such as checking that the numeric field contains digits only and that the text field is not empty. The output of this step is a user information message containing normalized text for the condition and a numeric value for the spending plan, together with the seat identifier or terminal identifier. The terminal transmits this user information message to the server.

### Step 4:

The server stores the user information and retrieves operational data.

The server uses, as input, the user information message from the terminal. The server first converts the condition text into a standardized character encoding and converts the spending plan into a fixed numeric type. The server then executes an insertion operation into a user information table in the database, creating a record that associates the condition, the spending plan, the seat identifier, and a timestamp. Next, the server retrieves resource inventory information and transaction history information by issuing structured queries to the database. These queries aggregate sales counts and filter out resources below a quantity threshold. The outputs of this step are three internal data sets: a normalized user information structure, a current inventory snapshot, and a summarized transaction history dataset for recent periods.

### Step 5:

The server summarizes operational data and constructs a prompt sentence.

The server uses, as input, the normalized user information, the inventory snapshot, and the transaction history dataset. The server performs data aggregation to compute, for each resource category, metrics such as stock level category (for example, “many,” “some,” “limited”) and sales frequency category (for example, “high,” “medium,” “low”). The server applies rules that map numeric quantities and counts into textual descriptors. Using these descriptors together with the condition and spending plan, the server concatenates fixed template strings and variable fields into a coherent prompt sentence. The output is a single prompt sentence string that encodes the user mood, the budget, the inventory status, and explicit instructions. For example, the server generates a prompt sentence such as:

“You are a recommendation engine for a restaurant.

User mood: wants a light meal.

User budget: 2000 yen.

Inventory status: many salads, some grilled chicken, limited steak, surplus vegetable soup.

Goal: Increase user satisfaction and reduce food waste by promoting items with high stock and low recent sales.

Task: Based on the mood, budget, and inventory status, propose 3 to 5 specific menu items that are actually available. For each item, output the name, a short description of 1 to 2 sentences, and a price in yen such that a typical selection of 1 to 2 items stays within the user budget. Return only the proposals, without additional commentary.”

### Step 6:

The server inputs the prompt sentence to the generative AI model and obtains response information.

The server uses, as input, the constructed prompt sentence string. The server tokenizes the prompt sentence into tokens recognizable by the generative AI model and passes these tokens, together with model configuration parameters, to the model. The generative AI model, implemented as a multi-layer transformer network, applies matrix multiplications, self-attention computations, non-linear activations, and normalization operations across its layers to generate a sequence of output token probabilities and selects tokens according to a decoding strategy. The server receives the resulting output tokens and converts them back into a text string. The output of this step is response information in the form of a text block that describes several proposed items with names, descriptions, and prices.

### Step 7:

The server parses the response information and generates structured candidate information.

The server uses, as input, the text response information from the generative AI model. The server applies parsing rules, such as pattern matching for item name lines, description lines, and price expressions, and extracts these elements into an intermediate representation. The server then constructs a list of candidate entries, each entry including a candidate name, a candidate description, and a candidate price converted into a numeric value. The server may perform normalization of currency symbols and numerical formats. The output of this step is structured candidate information, which is a collection of candidate data records suitable for further computation.

### Step 8:

The server evaluates and filters the candidate information based on system constraints.

The server uses, as input, the structured candidate information, the inventory snapshot, and the user spending plan. The server attempts to match each candidate name with a resource identifier in the inventory, for example by string comparison or lookup in a mapping table. For matched candidates, the server retrieves corresponding stock quantities and sales metrics. The server then computes a suitability score for each candidate by applying a scoring function that incorporates stock surplus level, sales frequency, price relative to the spending plan, and alignment with the user condition. The server discards candidates that correspond to resources below the stock threshold or that exceed the spending plan constraints. The output of this step is a filtered and ranked candidate list that includes only feasible and prioritized options.

### Step 9:

The server transmits the candidate list to the user information terminal and controls presentation.

The server uses, as input, the filtered and ranked candidate list and the seat identifier. The server converts the candidate list into a presentation message, which includes display labels, descriptions, prices, and any visual priority hints (for example, order or emphasis flags). The server sends this presentation message to the terminal associated with the seat identifier. The output is a transmitted data set that instructs the terminal which candidate options to display and in what order. The terminal receives the message, renders the candidate names, descriptions, and prices on the display, and enables touchable areas for selection. The terminal may also display additional information, such as total budget remaining, based on the candidate prices.

### Step 10:

The user selects candidates, and the terminal generates a selection result.

The user uses the terminal as input by touching one or more displayed candidate options. The terminal records each touch event and maps the event coordinates to the corresponding candidate entry in the presentation message. The terminal updates a local selection list data structure, adding or removing candidates when the user toggles their selections. When the user confirms the selection on the terminal (for example, by pressing a confirmation control), the terminal constructs a selection result message that contains identifiers or names of the selected candidates, their quantities if applicable, and the associated seat identifier. The output of this step is the selection result message, which the terminal sends to the server.

### Step 11:

The server generates order information based on the selection result and updates inventory.

The server uses, as input, the selection result message and the current inventory snapshot. The server matches each selected candidate to a resource identifier and determines the required quantity per resource. The server computes a total price and validates that the resources are still available by re-checking inventory quantities. The server then creates an order record, assigning a unique order identifier, and writes this order and its line items into the transaction history table in the database. Subsequently, the server calculates new inventory quantities by subtracting the ordered amounts from existing quantities and updates the corresponding records in the inventory table. The output of this step is finalized order information stored in the database and updated inventory information that reflects the committed order.

### Step 12:

The server confirms the order and triggers downstream equipment or services.

The server uses, as input, the finalized order information, including the order identifier and line items. The server generates an order confirmation message that includes the order identifier, selected resources, quantities, and possibly an estimated preparation time. The server transmits this confirmation message to the terminal for display to the user. In parallel, the server generates control messages for connected equipment or systems, such as preparation-area displays or processing devices, and sends these messages using a predefined protocol. The output of this step is a set of confirmation and control messages that cause external devices to start processing the order and inform the user that the order has been accepted.

It is also possible to incorporate an emotion engine for estimating the user's emotions. That is, the specific processing unit 290 may estimate the user's emotions using an emotion identification model 59, and perform specific processing based on the estimated emotions.

### EXAMPLE 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented recommendation systems that present options to users (for example, menu items, products, or services) typically rely on fixed business rules, simple filters, or static templates executed by a processor. Such systems often treat user input, inventory data, historical demand data, and contextual data (such as seasonal conditions or weather) in isolation or with limited interaction. As a result, these systems frequently generate recommendations that are suboptimal with respect to multiple, sometimes competing, constraints, such as user preferences, budget limitations, real-time inventory conditions, and efficient resource utilization.

Conventional systems further require developers or operators to manually encode complex decision logic into program code in order to balance these constraints. When business conditions change, such as the introduction of new items, fluctuations in supply, or variations in demand caused by environmental factors, the manually encoded logic must be updated and redeployed. This causes significant maintenance overhead and leads to latency between a change in operating conditions and a corresponding change in system behavior. In addition, many existing systems generate recommendations based on pre-defined templates that are not dynamically adapted to the actual state of resources, which results in excessive computation, wasted network calls, or repeated processing of options that are infeasible due to stock shortages or budget overruns.

Furthermore, even where so-called “AI-based” recommendation engines are employed, the integration between the core computing components (processor, memory, storage, and network) and the AI component is often coarse-grained. A generative AI model may be used merely to propose human-readable text, while the main system continues to perform recommendation logic using static algorithms, leaving the processor to reconcile AI output with data constraints in an ad hoc manner. This loose coupling can increase latency, require substantial post-processing, and reduce reliability, because the AI output may not be constrained by actual inventory or budget conditions at the time of generation.

Existing systems also tend to handle user interaction in a relatively static way. Even if a user-facing terminal is present, the terminal typically presents a fixed interface that is not dynamically tailored based on real-time detection of user presence or seating state. As a consequence, system resources can be underutilized when the terminal is idle, and user interaction may be delayed because the processing apparatus is not automatically activated and configured with appropriate guidance content at the moment the user is ready to provide input. This leads to increased user wait time and inefficient use of compute resources and network bandwidth.

From a computer-technology perspective, there is a need for an improved processing architecture in which the processor orchestrates the acquisition of user-related information, the aggregation of diverse operational data (supply status, sales performance, inventory, seasonal information, weather information), and the construction of constrained prompt sentences for a generative AI model in a coordinated pipeline. There is also a need for the processor to automatically verify and filter the AI-generated candidate options against real-time constraints, and to output only resource-feasible, budget-compliant options back to a user-facing device. Such an architecture should reduce the amount of unnecessary computation and network communication; shorten the end-to-end response time from user input to recommendation presentation; and improve the overall reliability and predictability of the system's behavior.

Accordingly, the technical problem to be solved is to improve the functioning of the computer system itself—namely, to provide a processor-controlled mechanism that (i) dynamically constructs and supplies context-rich, constraint-aware prompt sentences to a generative AI model; (ii) uses structured operational data and past usage data in a way that constrains and guides the generation process; (iii) automatically validates and filters AI outputs against real-time system data; and (iv) coordinates activation and display behavior of user-facing terminals—thereby enabling more efficient use of computing, storage, and network resources, and more timely and accurate presentation of feasible options to the user.

The specific processing by the specific processing unit 290 of the data processing device 12 in Example 2 is realized by the following means.

The present invention provides a server comprising a processor configured to acquire, via a user information input/output apparatus, user-related information including at least information regarding a user's desired items and an upper limit of expenditure; obtain, on the basis of the user-related information, supply status information, sales performance information, inventory information, season-related merchandise information, and weather-related information from an information storage apparatus; generate, by using the user-related information and the obtained supply status information, sales performance information, inventory information, season-related merchandise information, and weather-related information, a prompt sentence including condition information for specifying options suitable for the user-related information and output format information; input the generated prompt sentence into a generative AI model and acquire candidate option information generated by the generative AI model based on the prompt sentence; verify product information included in the candidate option information by comparing the product information with the inventory information and the information regarding the upper limit of expenditure, and generate final option information that satisfies budget constraints and resource utilization efficiency based on a verification result; and output the final option information to the user information input/output apparatus to present the final option information to the user. This enables the processor to orchestrate an integrated data-processing and AI-inference pipeline in which prompt sentences are dynamically constructed to encode real-time constraints, the generative AI model is guided to produce candidate options within a constrained solution space, and the server automatically filters and validates AI-generated content before presentation, thereby reducing unnecessary computation and communication, improving response time and consistency of recommendations, and enhancing the overall efficiency and reliability of the computer system.

The term “user-related information” refers to information associated with a user, including at least information indicating desired items to be obtained or consumed by the user and information indicating an upper limit of expenditure or budget specified by the user.

The term “user information input/output apparatus” refers to an apparatus that provides an interface for presenting information to a user and for receiving input from the user, such as a terminal device having at least a display unit and an input unit.

The term “supply status information” refers to information indicating a state of supply of items, including, for example, information about procurement conditions, delivery schedules, or availability from suppliers.

The term “sales performance information” refers to information indicating sales history or performance of items, including, for example, past sales quantities, sales frequency, or sales trends over time.

The term “inventory information” refers to information indicating a state of stock of items, including, for example, current stock quantities, stock locations, or remaining shelf life.

The term “season-related merchandise information” refers to information indicating whether an item is associated with a particular season or period, including, for example, flags or attributes that designate an item as seasonal or period-limited.

The term “weather-related information” refers to information indicating environmental conditions such as weather or climate, including, for example, temperature, precipitation, humidity, or weather forecasts.

The term “information storage apparatus” refers to any storage facility or device configured to store data, including, for example, a memory, a database system, or a storage server that stores supply status information, sales performance information, inventory information, season-related merchandise information, and weather-related information.

The term “prompt sentence” refers to a text-based instruction or query generated by the processor for input to a generative AI model, the text-based instruction or query including at least condition information for specifying options and output format information.

The term “condition information” refers to information included in a prompt sentence that defines constraints, requirements, or objectives for generating options, such as budget limits, preference conditions, or resource utilization conditions.

The term “output format information” refers to information included in a prompt sentence that specifies a structure, representation, or format in which a generative AI model is requested to output generated option information, such as a list format or a structured data format.

The term “generative AI model” refers to a machine learning model configured to generate text or structured content based on an input prompt sentence, including, for example, a neural network-based language model.

The term “candidate option information” refers to information representing one or more provisional or preliminary options generated by a generative AI model in response to a prompt sentence, before verification or filtering by the processor.

The term “product information” refers to information identifying or describing items that may be presented as options to a user, including, for example, item names, item categories, unit prices, and other attributes related to the items.

The term “final option information” refers to information representing one or more options that have been selected, verified, and, where necessary, filtered by the processor based on candidate option information, inventory information, and budget-related information, the options satisfying predetermined constraints such as budget and resource utilization efficiency.

The term “resource utilization efficiency” refers to a degree to which available resources, including inventory items or supply capacity, are used in a manner that reduces waste, improves turnover, or optimizes consumption in accordance with predefined criteria.

The term “detection apparatus” refers to a device or sensor configured to detect a physical state related to a user or terminal, such as a seating state of a user at a terminal or a presence state of a user in a predetermined area.

The term “seating state” refers to a physical condition in which a user is seated at or in proximity to a user information input/output apparatus, as detected by the detection apparatus.

The term “information processing apparatus” refers to a hardware and software system that includes at least a processor and memory and that executes processing related to acquisition, analysis, generation, or output of information, including server-side processing in the system.

The term “user guidance information” refers to information generated for presentation to a user in order to prompt the user to perform an action, such as entering user-related information, confirming options, or proceeding with an interaction flow.

The term “initial presentation screen” refers to a first or early display screen presented to a user on the user information input/output apparatus when an interaction session is started, the screen including at least user guidance information or input prompts.

The term “past usage history information” refers to information indicating historical usage patterns of the system or items by users, including, for example, past selections, past orders, or past interactions.

The term “resource consumption history information” refers to information indicating past consumption or usage of resources, including, for example, historical stock depletion, waste quantities, or item disposal records.

The term “option information” refers to information that defines one or more alternatives or choices that can be presented to a user, each alternative including at least one item and associated data such as quantity and price.

In one embodiment, a server, a terminal, and a user cooperate to implement the claimed system. The server includes at least one processor, a main memory, a non-volatile storage device, and a network interface, and executes server software such as an operating system (for example, a general-purpose server operating system), a web server, and an application server. The terminal includes a processor, a display unit, an input unit such as a touchscreen, and a network communication module, and executes client software such as a web browser or a dedicated application. The server and the terminal communicate via a wired or wireless network using a communication protocol such as HTTPS.

The server manages one or more information storage apparatuses implemented by database management systems and storage devices. The server stores supply status information, sales performance information, inventory information, season-related merchandise information, weather-related information, past usage history information, and resource consumption history information in relational tables or document-based data structures. The server uses a structured data model, for example, tables for items, stock levels, transaction records, season flags, and weather logs, with indexed fields for item identifiers, timestamps, location identifiers, and category codes. The server accesses these data structures through database queries and in-memory caching.

The server uses a generative AI model implemented by a neural network, for example a transformer-based language model trained on natural language text and domain-specific data. The server executes the generative AI model either on a local inference engine coupled to a graphics processing unit or on an external AI service accessible over a network. The neural network architecture can include an embedding layer, multiple self-attention layers, feed-forward layers, and a final output layer that produces token probability distributions. The server configures the generative AI model with hyperparameters such as number of layers, number of attention heads, embedding dimension, and vocabulary size. The server stores learned parameters (weights and biases) in a model storage component and loads them into memory when performing inference.

The server trains or fine-tunes the generative AI model by using training data that consists of pairs of input prompt sentences and desired option outputs. The server uses a loss function such as cross-entropy between predicted tokens and ground-truth tokens and applies an optimization algorithm such as stochastic gradient descent or a variant thereof to update the model weights. The server can use data augmentation techniques such as paraphrasing, synonym replacement, and controlled noise injection in numeric values to make the model robust to variations in user input. The server stores the training data and configuration parameters in the storage apparatus, and the server executes training or fine-tuning procedures offline or periodically.

The server constructs a prompt sentence by combining user-related information and operational data into a structured natural language instruction. The server represents user-related information internally as a structured record, for example a record containing fields for desired item category, specific item keywords, upper limit of expenditure, number of users, and time of use. The server maps this structured record and associated data from the information storage apparatus into an intermediate representation, for example a set of attribute-value pairs including current stock levels, historical sales rates, season flags, and weather descriptors. The server uses a template engine or a rule-based generator to convert the intermediate representation into a prompt sentence.

The server configures the prompt sentence to include both condition information and output format information. For example, the server generates a prompt sentence such as:

“The user wants to eat tuna and has a budget of 1000 yen. Current inventory: lean tuna sushi (120 yen, 20 units in stock), fatty tuna sushi (250 yen, 5 units in stock), egg sushi (80 yen, 50 units in stock). Sales performance: lean tuna sushi and egg sushi are popular; fatty tuna sushi sells slowly. Weather: sunny, 25 degrees Celsius. Considering supply status, sales performance, inventory, and the user's budget, propose the optimal combination of sushi within 1000 yen that also helps reduce food loss by using items with higher stock. Return your answer as a numbered list with item names, quantities, and total price.”

In another example, the server generates a prompt sentence such as:

“The user wants to eat tuna and salmon and has a budget of 1500 yen. Current inventory: lean tuna sushi (120 yen, 20 units in stock), fatty tuna sushi (250 yen, 5 units in stock), salmon sushi (130 yen, 25 units in stock), cucumber roll (60 yen, 40 units in stock). Sales performance: lean tuna sushi and salmon sushi are very popular in the evening, fatty tuna sushi sells slowly, cucumber rolls have high stock. Weather is rainy and 18 degrees Celsius. Considering supply status, sales performance, inventory, seasonal conditions (none), and the user's budget, propose two optimal sushi combinations that satisfy the user, fit within 1500 yen, and help reduce food loss by using high-stock items. Return your answer as a numbered list with each combination name, items and quantities, and total price.”

The server configures the generative AI model to tokenize the prompt sentence, apply multi-head attention over the tokens, and output a sequence of tokens representing candidate option information. The server sets generation parameters such as maximum token length, temperature, and probability threshold to control diversity and determinism. The server uses an algorithm such as beam search or nucleus sampling to select the output sequence. The server then decodes the tokens to obtain a candidate text description of options.

The server uses a parser module to convert the candidate text into a structured candidate option information representation. The server configures the parser to recognize patterns requested in the output format information of the prompt sentence, such as numbered lists or key-value lines. The server maps item names and quantities in the candidate text to internal item identifiers using a lookup table and string-matching rules, including approximate matching algorithms to handle minor spelling variations. The server verifies the candidate option information by comparing quantities and items against inventory information and by computing total cost using unit prices stored in the inventory records.

The server uses a validation algorithm to ensure that each candidate option satisfies constraints. The server calculates total expenditure by summing the products of unit prices and quantities. The server compares the total expenditure with the upper limit of expenditure in the user-related information. The server discards options that exceed the budget or that require items with insufficient stock. The server optionally applies scoring rules that use sales performance and resource consumption history to favor options that improve resource utilization efficiency, such as options that increase consumption of slow-moving items or items close to expiration dates. The server computes a score for each candidate based on factors such as stock ratio, historical waste rate, and expected demand, and the server selects one or more top-scoring options as final option information.

The server outputs the final option information to the terminal by sending structured data including item names, quantities, and prices, together with explanation texts. The terminal receives the output, parses it, and presents it on the display unit in a user-friendly layout. The terminal may render lists, images, and labels such as “seasonal” or “food-loss reduction” based on flags received from the server. The terminal allows the user to confirm or adjust a selection and then transmits confirmation data back to the server. The server updates inventory records and sales performance records in the information storage apparatus accordingly.

In one embodiment, the terminal includes a detection apparatus such as a seat sensor, a proximity sensor, or a camera-based presence detector. The terminal detects that the user is seated or present at a particular location. The terminal transmits detection information to the server. The server receives the detection information and automatically activates an information processing routine and initializes the user interface on the terminal. The server constructs a prompt sentence to obtain user guidance information from the generative AI model, for example:

“A user has just been seated at a table and is about to place an order using a digital terminal. Generate a short, friendly guidance message that asks the user to enter their food preferences and budget in order to receive optimized recommendations that consider current availability and reduce waste.”

The server inputs this prompt sentence into the generative AI model and receives user guidance information. The server transmits the user guidance information to the terminal. The terminal displays an initial presentation screen containing the guidance text and input controls. This dynamic generation of guidance based on detection events allows the system to present appropriate content at the correct time, reducing idle processing and unnecessary network traffic.

From a technical standpoint, the server improves computer performance by structuring data processing and AI inference in a constrained pipeline. The server does not simply use the generative AI model to generate arbitrary recommendations; instead, the server constructs prompt sentences that encode real-time, machine-readable constraints derived from multiple databases. The server thereby reduces the search space that the generative AI model must explore, which results in more efficient inference. The server further reduces post-processing work because candidate outputs are more likely to satisfy constraints, which shortens validation and reduces the likelihood of discarding large portions of AI output.

The server also improves data management by maintaining consistent and normalized records of supply status information, sales performance information, inventory information, and history information, and by mapping these records directly into the prompt sentences and validation algorithms. This integrated design reduces redundancy and prevents inconsistent states where recommendations rely on stale or incomplete data. By verifying candidate option information against the current state of the databases before presentation, the server reduces the risk of presenting infeasible options, which in turn reduces error-handling overhead and repeated user interactions.

The server reduces communication load by limiting the number of round trips between the server and the generative AI model. The server aggregates all necessary contextual data into a single prompt sentence instead of sending multiple, incremental requests. This design decreases network latency and improves throughput of AI inference requests. The server can also cache portions of prompt sentences related to relatively static data (such as seasonal descriptions) and dynamically insert only fast-changing data (such as inventory levels) to further reduce computation overhead.

The generative AI model processes information in a manner that is different from conventional human decision-making or simple rule-based automation. The model internally computes attention weights between tokens in the prompt sentence, including numeric values representing stock, price, and budget, and textual labels representing popularity and seasonal attributes. By training the model on combinations of such information, the model learns patterns of trade-offs between cost, diversity of items, and resource utilization. The model does not follow a fixed set of business rules written by human operators; instead, the model learns from data how to balance constraints and produce combinations that may not be captured by simple heuristic rules. The server leverages this property to achieve higher accuracy and better adaptation to changing conditions than a purely rule-based algorithm.

The server configures the training process of the generative AI model to emphasize compliance with constraints by incorporating penalty terms into the loss function that penalize outputs that exceed budgets, use unavailable items, or fail to minimize waste according to resource consumption history. The server collects training examples where correct outputs demonstrate adherence to such constraints and uses them to update model weights. This training method causes the model to internalize non-trivial relationships between user preferences and operational constraints, which leads to more reliable outputs at inference time and reduces the amount of external correction required.

In alternative embodiments, the server can employ a different model architecture, such as a recurrent neural network or a hybrid architecture that combines rule-based pre-filtering with generative sequence modeling. The server can also adapt the system to different domains beyond food ordering, such as recommending products, services, or schedules, by changing the schema of stored information and the content of prompt sentences. In each domain, the server continues to apply the same core architecture of generating constraint-aware prompt sentences, invoking a generative AI model, and validating candidate option information against real-time data.

In another embodiment, the server partitions the generative AI processing into multiple stages. The server uses a first generative AI model to interpret free-form user requests into normalized user-related information, such as standardized item categories and numerical budgets. The server uses a second generative AI model, which is specialized in option composition, to generate candidate option information. The server coordinates these models by passing intermediate structured representations between them. This modular design allows the server to update or replace one model without affecting the other and enables domain-specific optimization of each model, thereby improving scalability and computational efficiency.

In yet another embodiment, the server executes real-time optimization algorithms alongside the generative AI model. The server uses the generative AI model to propose candidate sets of items and then applies a combinatorial optimization algorithm, such as a branch-and-bound or greedy algorithm, on top of the candidate sets to refine selections according to strict constraints on stock and cost. This layered approach leverages the generative AI model's ability to propose diverse, high-level solutions while ensuring that the final options satisfy rigorous operational constraints. This combination leads to improved precision and robustness compared to purely human-designed or purely AI-generated solutions.

By structuring the system as described above, the server, the terminal, and the user operate within a coordinated architecture that goes beyond simple automation of human tasks. The server improves the internal functioning of the computer system by reducing computation time, improving accuracy of generated options, optimizing data management and storage, and limiting communication overhead. The use of a generative AI model, trained and constrained as described, provides a technical mechanism that integrates real-time data and historical information into the option generation process in a way that conventional rule-based or static template systems cannot achieve.

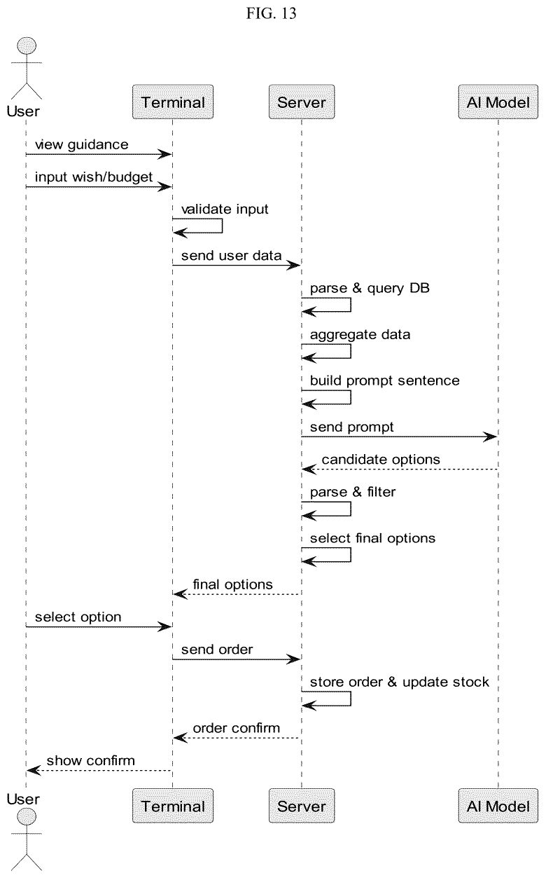

The following describes the processing flow using FIG. 13.

### Step 1:

The terminal displays an initial guidance screen to the user.

The input to this step is display configuration data and guidance text received from the server at a previous timing or stored locally. The output of this step is a rendered user interface that is visible on the display unit of the terminal. The terminal executes client software to draw text areas, buttons, and input fields on the touchscreen and allocates memory buffers for the UI components.

### Step 2:

The user reads the guidance on the terminal and inputs user-related information.

The input to this step is the displayed UI and the user's physical touch operations on the touchscreen. The output of this step is raw input signals representing touch coordinates, key presses, and entered characters. The terminal converts these signals into structured data fields such as desired item keywords, budget value, and number of persons by mapping screen coordinates to UI elements and by assembling character codes into text strings.

### Step 3:

The terminal validates and packages the user-related information.

The input to this step is the structured user-related information generated in Step 2. The output of this step is a validated user-related information object. The terminal performs data processing by checking that mandatory fields are not empty, confirming that the budget value is numeric and non-negative, and truncating excessively long text according to preset limits. The terminal then encapsulates the sanitized values into a data structure such as a JSON object or a key-value map in memory.

### Step 4:

The terminal transmits the user-related information to the server.

The input to this step is the validated user-related information object from Step 3. The output of this step is a network request message sent over a communication channel. The terminal establishes an HTTPS connection with the server, serializes the data structure into a text-based format, and writes the serialized bytes into the network buffer. The terminal tags the request with a unique session identifier so that the server can associate subsequent responses with the correct user session.

### Step 5:

The server receives and parses the user-related information.

The input to this step is the network request message from the terminal. The output of this step is an internal representation of the user-related information stored in the server's memory. The server's network interface receives the bytes, the web server component decodes the HTTP envelope, and an application layer parses the body of the message. The server performs data processing by deserializing the JSON or equivalent format into structured variables in memory and by attaching a timestamp and a session identifier.

### Step 6:

The server retrieves operational data from one or more information storage apparatuses.

The input to this step is the user-related information parsed in Step 5, including at least desired items and budget. The output of this step is a set of data records for supply status information, sales performance information, inventory information, season-related merchandise information, weather-related information, past usage history information, and resource consumption history information. The server generates and executes database queries against relational or document stores, using item categories, store identifiers, and temporal ranges derived from the user-related information as query conditions. The server receives query results, loads them into memory, and may apply indexing or caching to accelerate subsequent access.

### Step 7:

The server aggregates and summarizes the operational data for prompt construction.

The input to this step is the collection of operational data records retrieved in Step 6. The output of this step is an intermediate aggregated data structure containing compact summaries such as per-item stock levels, popularity scores, season flags, and weather descriptors. The server performs data processing by grouping records by item identifier, summing stock quantities, computing average daily sales, calculating waste ratios from resource consumption history, and determining whether each item is seasonal or standard. The server then converts numeric metrics into concise textual descriptors (for example, “20 units in stock”, “very popular”, “slow moving”) and stores them in the aggregated data structure.

### Step 8:

The server generates a prompt sentence for the generative AI model.

The input to this step is the user-related information from Step 5 and the aggregated data structure from Step 7. The output of this step is a text-form prompt sentence. The server executes a prompt-generation module that inserts values from the user-related information and aggregated data into a predefined template. The server performs data processing by concatenating text segments, interpolating variables such as item names, prices, stock levels, and weather conditions, and appending explicit instructions about constraints and output format. For example, the server generates a prompt sentence such as: “The user wants to eat tuna and has a budget of 1000 yen. Current inventory: lean tuna sushi (120 yen, 20 units in stock), fatty tuna sushi (250 yen, 5 units in stock), egg sushi (80 yen, 50 units in stock). Sales performance: lean tuna sushi and egg sushi are popular; fatty tuna sushi sells slowly. Weather: sunny, 25 degrees Celsius. Considering supply status, sales performance, inventory, and the user's budget, propose the optimal combination of sushi within 1000 yen that also helps reduce food loss by using items with higher stock. Return your answer as a numbered list with item names, quantities, and total price.”

### Step 9:

The server sends the prompt sentence to the generative AI model and receives candidate option information.

The input to this step is the prompt sentence generated in Step 8. The output of this step is candidate option information in textual form. The server creates a request payload that includes the prompt sentence and model configuration parameters and transmits the payload to the generative AI model via an inference API or local inference engine. Inside the generative AI model, the prompt is tokenized, processed through multiple attention layers and feed-forward layers, and decoded into an output token sequence. The server receives the output token sequence as text, which represents candidate option information such as recommended combinations of items and their quantities.

### Step 10:

The server parses and structures the candidate option information.

The input to this step is the candidate option information text received in Step 9. The output of this step is a structured candidate option data set. The server executes a parsing routine that scans the text line by line or token by token, detects numbering or delimiter patterns, and extracts item names, quantities, and partial prices according to the requested format. The server performs data processing by mapping extracted item names to internal item identifiers using a lookup table and string similarity matching and by converting textual quantities and prices into numeric values. The server stores the parsed results in an in-memory structure such as a list of candidate combinations, each containing item identifiers, quantities, and prices.

### Step 11:

The server validates candidate options against inventory and budget constraints.

The input to this step is the structured candidate option data set from Step 10, together with the inventory information and upper expenditure limit from previous steps. The output of this step is a filtered list of valid candidate options. The server performs data processing by, for each candidate combination, calculating a total cost as the sum of unit price multiplied by quantity for each item, comparing the total cost with the budget, and verifying that requested quantities do not exceed available stock recorded in the inventory information. The server flags and discards candidate combinations that exceed the budget or use out-of-stock items. The server may also compute a resource utilization score for each remaining candidate based on waste ratios and stock levels and attach the score as a numeric attribute.

### Step 12:

The server selects final option information based on validation and scoring.

The input to this step is the filtered list of valid candidate options from Step 11, each with an optional resource utilization score. The output of this step is final option information to be presented to the user. The server performs data processing by sorting or ranking candidate options according to predetermined criteria, such as maximizing resource utilization score while staying within budget, or balancing popularity and waste reduction. The server selects one or more top-ranked options and assembles their item lists, quantities, and total prices into a final option data structure. The server also generates explanation text that describes why each option is recommended, using template-based text generation driven by the scores and attributes.

### Step 13:

The server transmits the final option information to the terminal.

The input to this step is the final option data structure from Step 12. The output of this step is a response message delivered to the terminal. The server serializes the final option information and explanation text into a structured response format and sends the response via HTTPS to the terminal associated with the user session. The server may compress the data to reduce bandwidth and tag the message with the session identifier and a response type code.

### Step 14:

The terminal receives and renders the final option information.

The input to this step is the response message from the server containing the final option information. The output of this step is a visual presentation of selectable options on the terminal display. The terminal decodes the response, parses the structured data, and constructs UI components such as list items, cards, or buttons for each option. The terminal performs data processing by mapping item identifiers to display names and images (if stored locally), calculating layout positions, and generating text labels for total prices and explanations. The terminal then updates the screen buffer and displays the recommended options to the user.

### Step 15:

The user reviews the recommended options and selects an option.

The input to this step is the visual presentation of final option information on the terminal. The output of this step is user selection data. The user examines the options, compares prices, items, and explanations, and performs touch input to select a preferred option and, if allowed, adjust quantities. The terminal converts the user's touch operations into an internal selection state that identifies one of the final options and any quantity adjustments.

### Step 16:

The terminal packages and sends the user's selection to the server as an order request.

The input to this step is the user selection state created in Step 15. The output of this step is an order request message sent to the server. The terminal constructs an order object that includes selected item identifiers, quantities, calculated total price, and the session identifier. The terminal performs data processing by recomputing total price from unit prices and quantities to ensure consistency and then serializes the order object into a network message, which is transmitted via HTTPS to the server.

### Step 17:

The server finalizes the order and updates inventory records.

The input to this step is the order request message received from the terminal. The output of this step is a stored order record and updated inventory information. The server parses the order message, verifies again that quantities are within available stock, and starts a transaction in the database. The server inserts a new row or document representing the order into an order history structure and decrements stock quantities for each ordered item in the inventory structure. The server commits the transaction to ensure atomicity. The server then generates a confirmation payload including an order identifier and an estimated preparation time.

### Step 18:

The server sends an order confirmation to the terminal, and the terminal presents the confirmation to the user.

The input to this step is the confirmation payload created in Step 17. The output of this step is a confirmation screen shown to the user. The server transmits the confirmation payload to the terminal. The terminal receives the payload, parses the order identifier and related information, and renders a confirmation UI that shows the ordered items, total price, order identifier, and estimated preparation time. The user visually confirms that the order has been accepted.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented recommendation and ordering systems typically treat user input, backend operational data, and machine-generated suggestions as loosely coupled components. A user interface generally collects only coarse user preferences or a budget, a backend transaction system separately manages inventory and sales, and a recommendation module or rules engine presents options without deeply integrating real-time operational context. As a result, several technical problems arise in the operation of information processing systems.

First, existing systems lack a unified data-processing pipeline that concurrently handles multi-modal user state information (including detected emotion), fine-grained operational data (such as real-time inventory, sales, procurement, environmental, and seasonal data), and outputs from a generative artificial intelligence model. Without such integration, processors must repeatedly execute separate data access and transformation procedures, which increases processing latency, causes redundant database queries, and leads to inefficient use of computation and memory resources. This fragmented architecture degrades the responsiveness and scalability of the system, particularly under high user traffic.

Second, many systems invoke a generative artificial intelligence model using manually crafted or static prompt text that does not reflect current machine state, storage contents, or ongoing resource usage. When the prompt sentence does not encode precise, structured context derived from system logs and real-time records, the model tends to produce recommendations that are misaligned with actual inventory, historical sales trends, or system objectives such as reducing waste. This not only diminishes the practical utility of the model's output but also forces the host processor to run additional filtering and correction processes, further consuming computational resources and increasing end-to-end latency.

Third, conventional architectures do not exploit user emotion information and user state history as first-class inputs to the core recommendation and resource-management loop. Emotion or mood, if used at all, is frequently handled by separate application logic outside the main transaction and data-processing path. This segregation leads to duplicated state handling, inconsistent use of emotion information across requests, and complex control flow between front-end devices and backend servers. Consequently, processors cannot systematically optimize both user-facing options and backend resource usage in a single, coherent decision procedure.

Fourth, typical systems update inventory records and usage logs only after an order is finalized, and do so in a manner that is not directly connected to future prompt generation or option structuring. Because the updated usage and inventory records are not tightly fed back into the prompt-construction logic, the generative artificial intelligence model does not continuously “see” the latest system state. The host processor must then either operate on stale context or perform ad hoc recalculation, which leads to suboptimal load distribution, poor waste reduction performance, and unnecessary recomputation.

Accordingly, there is a need for an improved computer-implemented system and server-side processing architecture in which a processor is configured to: (i) acquire and integrate user state information, spending plan information, and emotion information; (ii) aggregate and normalize operational context such as inventory, sales, procurement, environmental, and seasonal information; (iii) generate context-rich prompt sentences tailored to a generative artificial intelligence model; (iv) structure the model's output into machine-usable option data; and (v) update usage and inventory records in a feedback loop that directly influences subsequent prompt generation and option presentation. By embedding these capabilities in a single, coherent processing configuration, the system can reduce redundant computation, lower latency, improve consistency of state handling, and enhance the overall technical performance of recommendation and resource-management functions executed by the processor.

The specific processing by the specific processing unit 290 of the data processing device 12 in Application Example 2 is realized by the following means.

The present invention provides a server comprising a processor configured to provide an interface for acquiring user state information and user spending plan information, analyze user input information acquired through the interface to estimate a user state including emotion information, acquire inventory information, sales information, procurement information, environmental information, and seasonal information from a data storage device and generate contextual information by integrating the contextual information with the user state, generate a prompt sentence based on the contextual information for instructing a generative artificial intelligence model to present optimal options in consideration of efficient resource utilization and reduction of waste, input the prompt sentence to the generative artificial intelligence model and analyze output information obtained from the generative artificial intelligence model to structure the options, output the structured options to a display device to present the structured options to the user and generate request information in response to a selection operation by the user or an automatic decision based on the emotion information, and update a usage record and an inventory record of a processing target resource based on the request information and reflect an updated result in subsequent generation of the prompt sentence and in subsequent presentation of the options. This enables the server to implement an integrated, feedback-driven computation pipeline in which multi-modal user state, emotion, and operational context are normalized into machine-readable context data, converted into optimized prompt sentences for the generative artificial intelligence model, and immediately propagated back into storage records and subsequent prompt construction, thereby reducing redundant data-access operations, lowering processing latency, improving the alignment between model outputs and real-time system state, and enhancing the efficiency and technical performance of option presentation and resource management executed by the processor.

The term “user state information” refers to information indicating a condition of a user, including at least one of a physical condition, a psychological condition, a preference, a mood, or an intention of the user, as derived from explicit user input or sensor measurements.

The term “user spending plan information” refers to information indicating a planned or allowable amount of expenditure by a user, including at least one of a budget amount, a price range, or a constraint on spending for a transaction or a period.

The term “interface” refers to a hardware and software combination configured to receive input from a user and to present output to the user, including at least one of a graphical user interface, a touch interface, a voice interface, or any other human-machine interaction mechanism.

The term “emotion information” refers to information representing an estimated emotional state of a user, including at least one of happiness, sadness, anger, fatigue, excitement, relaxation, or neutrality, derived from analysis of at least one of facial image data, voice data, or textual expressions.

The term “inventory information” refers to information indicating an availability state of a resource, including at least one of a type identifier, a quantity, a remaining quantity, an expiration attribute, or an availability flag stored in a data storage device.

The term “sales information” refers to information indicating a record of completed transactions, including at least one of an item identifier, a quantity sold, a sale time, a sale price, and an aggregation of such records over a period.

The term “procurement information” refers to information indicating acquisition of resources for use in a system, including at least one of a purchased resource identifier, a purchased quantity, a procurement time, and a freshness or quality attribute.

The term “environmental information” refers to information indicating conditions external to a user and a server, including at least one of weather conditions, temperature, humidity, time of day, or location-related conditions.

The term “seasonal information” refers to information indicating a temporal relationship between a resource and a time period, including at least one of whether a resource is in season, preferred in a particular season, or associated with a seasonal event.

The term “data storage device” refers to any hardware configured to store digital data, including at least one of a memory device, a magnetic storage device, an optical storage device, or a solid-state storage device, used to store inventory information, sales information, procurement information, environmental information, or seasonal information.

The term “contextual information” refers to information generated by combining user state information with at least one of inventory information, sales information, procurement information, environmental information, or seasonal information, and representing a state of a system at a time of processing.

The term “prompt sentence” refers to a text sequence generated by a processor that encodes contextual information and instructs a generative artificial intelligence model to perform a specific generation task, including at least generation of options suitable for a user or for resource management.

The term “generative artificial intelligence model” refers to a computational model trained using machine learning techniques and configured to generate output data, including at least natural language text, based on an input prompt sentence and learned patterns from training data.

The term “output information” refers to information produced by the generative artificial intelligence model in response to the prompt sentence, including at least one of natural language descriptions, structured data, or scores associated with proposed options.

The term “options” refers to selectable entities presented to a user or used by a system, including at least one of products, services, menu items, or recommended actions generated or refined based on output information from the generative artificial intelligence model.

The term “structure the options” refers to converting unstructured or semi-structured output information from the generative artificial intelligence model into a machine-usable representation, including at least one of assigning identifiers, grouping attributes, adding prices, or associating metadata such as tags or priority values.

The term “display device” refers to hardware capable of presenting visual information to a user, including at least one of a monitor, a touch panel, a handheld terminal display, or a head-mounted display.

The term “request information” refers to information generated in response to a user selection operation or an automatic decision, including at least one of identifiers of selected options, quantities, user identifiers, and timing information for use in subsequent processing.

The term “processing target resource” refers to an entity managed by a system in connection with options, including at least one of a physical item, a service capacity, or a computational resource whose usage and inventory are tracked.

The term “usage record” refers to information indicating a history of utilization of a processing target resource, including at least one of a consumed quantity, a usage time, and an association with a user or a transaction.

The term “inventory record” refers to information indicating a current or historical inventory state of a processing target resource, including at least one of a remaining quantity, a decrement due to usage, and an update time.

The term “detection unit” refers to a sensing component configured to detect seating or presence of a user at a location, including at least one of a pressure sensor, a proximity sensor, an optical sensor, or a combination thereof.

The term “information processing device” refers to an electronic apparatus including at least a processor and a memory, configured to execute software for providing the interface, communicating with a server, and presenting or collecting option-related information.

The term “imaging device” refers to hardware configured to capture image data, including at least one of a camera, an image sensor, or an imaging module integrated in an information processing device.

The term “audio acquisition device” refers to hardware configured to acquire sound data, including at least one of a microphone, an array of microphones, or an audio sensor integrated in an information processing device.

The term “user state history” refers to stored information representing past user state information or emotion information associated with prior interactions of a user, including timestamps and contextual identifiers.

The term “priority information” refers to data indicating a relative importance or recommendation level of options or resources, calculated based on at least one of past inventory information, past sales information, user state history, or system objectives such as efficient resource utilization or sales promotion.

In one embodiment, a server, a plurality of terminals, and at least one user cooperate to implement the present invention. The server comprises at least one central processing unit (CPU), a main memory, a non-volatile storage device, and a network interface. The terminal comprises at least one processor, a display device, an input device such as a touch panel, an imaging device such as a camera, and an audio acquisition device such as a microphone. The user interacts with the terminal, and the terminal communicates with the server over a communication network such as a local area network or a wide area network.

The server executes an operating system and application software implemented, for example, in a general-purpose programming language. The server stores inventory information, sales information, procurement information, environmental information, and seasonal information in a data storage device such as a relational database management system or a document-oriented database. The server also stores a trained generative AI model, a trained emotion estimation model, and trained auxiliary models, and loads their weights into memory at runtime.

The terminal executes a client application, for example on a handheld information processing device or a tablet. The terminal displays an interface that allows the user to input user state information and user spending plan information. The terminal presents text fields, selection lists, and buttons for specifying at least a desired taste or style, a preferred category of item, and a numeric budget. The terminal also acquires image data of the user's face through the imaging device and audio data of the user's speech through the audio acquisition device. The terminal encodes the image data (for example as compressed image frames) and the audio data (for example as compressed audio signals) and transmits the user input information to the server via a network communication protocol such as HTTPS.

The server receives the user input information from the terminal and stores the information in a structured data record in the main memory. The server parses natural language text input using a natural language processing component. The server, for example, executes a tokenizer and a part-of-speech tagger, detects numerical expressions representing spending plan information, and identifies terms indicating a preference or a requested style. The server represents the parsed text as a feature vector, including token indices, part-of-speech tags, and numeric budget values.

The server applies an emotion estimation model to the image data and the audio data. In one embodiment, the emotion estimation model is a neural network that receives as input a set of facial landmarks and a representation of the user's voice. The server first applies a face-detection algorithm, for example based on a convolutional neural network, to locate the user's face in the image and to compute a set of landmark points representing eye, mouth, and brow positions. The server also computes acoustic features from the audio signal, such as Mel-frequency cepstral coefficients and pitch-related features. The server concatenates the visual feature vector and the acoustic feature vector and inputs the concatenated vector to a multi-layer neural network that outputs probabilities for a plurality of emotion classes, such as “happy,” “tired,” “neutral,” and “sad.” The server stores the resulting emotion information as part of the user state information.

The server retrieves operational context from the data storage device. The server accesses an inventory data table to obtain an identifier, a current stock quantity, and an expiration attribute for each resource. The server accesses a sales data table to obtain counts of items sold within a recent time window. The server accesses a procurement data table to obtain information on recently acquired resources, including acquisition times and quality attributes. The server accesses an environmental data store or an external service to obtain weather-related environmental information, such as temperature and precipitation. The server accesses seasonal information tables that map time-of-year to preferred resources. The server loads these data into memory and normalizes them into a unified context representation.

The server generates contextual information by integrating the user state information, including emotion information and spending plan information, with the operational context. The server, for example, constructs a data structure that associates each candidate item with one or more attributes such as stock level, sales performance, procurement freshness, seasonal suitability, environmental suitability, and match to user state and spending plan. The server computes a numerical score for each candidate item using a non-linear scoring function that combines these attributes by weighting factors stored in memory. The server thereby produces context-refined candidate item data that are not directly observable from raw databases.

The server constructs a prompt sentence to be supplied to the generative AI model. The server converts at least a subset of the contextual information into natural-language text. The server inserts, for example, the user's expressed desire, the estimated emotion information, the budget range, a list of overstocked items, a description of environmental conditions, and one or more system objectives such as “reduce waste” into a predefined textual template stored in memory. The server thus generates a prompt sentence that explicitly encodes machine-state information in a form consumable by the generative AI model.

In one example, the server generates the following prompt sentence:

“Customer's textual request is ‘something light and refreshing’.

Customer emotion is ‘tired but relaxed’.

Budget is 1,000 yen.

Weather is hot and sunny (32 degrees Celsius).

Overstocked ingredients are salmon and cucumber.

Underperforming items are salmon roll and cucumber maki.

Generate three sushi menu recommendations that fit within the budget, use overstocked ingredients to reduce waste, and feel light and refreshing for hot weather. Output Japanese item names and one-sentence descriptions.”

In another example, the server generates the following prompt sentence:

“Customer said ‘I am a bit tired today and want tuna’.

Emotion analysis indicates the customer is tired and wants comfort.

Budget is 1,000 yen.

Weather is rainy and cool.

Inventory has high stock of tuna and seaweed and low stock of eel.

Sales data indicate tuna rolls have low sales today.

Generate three comforting tuna-based sushi menus under 1,000 yen that help reduce tuna overstock. Describe each in Japanese with a short explanation.”

The server inputs the prompt sentence to the generative AI model. The generative AI model is, for example, a transformer-based sequence model that has been trained on pairs of input prompts and output option descriptions. The generative AI model comprises an embedding layer, a plurality of self-attention layers, and a decoding layer, and has been trained using stochastic gradient descent with backpropagation and a cross-entropy loss function. During training, the model's weights were updated based on prediction error between generated text and reference text, and data augmentation was used to vary phrasing of prompts and outputs, thereby improving robustness. The server invokes the model with the generated prompt sentence and a set of parameters such as maximum output length and sampling temperature, and the model outputs a sequence of tokens representing natural-language descriptions of options.

The server converts the natural-language text output of the generative AI model into structured options. The server, for example, performs pattern-based parsing and token classification on the generated text, recognizing item names, descriptions, and price indications. The server then matches the recognized item names against identifiers stored in the inventory and sales data tables, using approximate string matching algorithms and mapping tables. When the generative AI model outputs a high-level description, the server maps the description to one or more specific resources based on resource attributes and rules stored in the server memory. The server thus obtains a set of options represented as structured data including item identifiers, quantities, and explanatory texts.

The terminal receives the structured options from the server and renders them for the user. The terminal, for example, displays a list of options, where each option shows a name, a price, an image, and a short generated description. The user selects one or more options using the touch panel. The server receives request information from the terminal indicating the user's selection. The server updates a usage record and an inventory record of the corresponding processing target resources in the data storage device. The server decrements the inventory quantities, increments sales counts, and logs these updates with timestamps. The server then uses the updated records in subsequent prompt generation and option selection, thereby forming a closed-loop feedback system.

The server in this embodiment improves computer technology in several ways. The server maintains a unified data-flow pipeline in which multi-modal user state, emotion, and operational context are integrated into contextual information, formatted into a prompt sentence, and immediately fed back into storage structures after each request. The server reduces redundant database access and recomputation by caching intermediate features and by computing scores and mappings only once per interaction, which reduces overall latency. The server also reduces communication load, because the terminal transmits only raw input and the server transmits only structured options, while the heavy contextual reasoning is performed on the server-side with optimized data access patterns.

The server uses the generative AI model in a way that is not a mere automation of human judgment. The server constructs prompt sentences that encode system state variables, resource usage goals, and technical constraints that are not visible to a human user. The generative AI model processes these machine-oriented signals and generates outputs constrained by the modeled relationships between resource attributes and user states. The server uses model outputs as inputs to algorithmic matching and scoring routines that consider inventory and sales constraints, thereby altering the actual control flow of resource allocation in the system and improving computational efficiency and precision compared to human-only or rule-only systems.

The server structures the internals of the generative AI model use in a non-conventional manner. The server uses model outputs not as final answers but as high-level templates, and then executes deterministic mapping and scoring algorithms that correct and augment the outputs based on current inventory and sales data. This use of the model introduces a two-stage decision process in which a flexible language model produces candidate descriptions, and a deterministic mapping stage enforces strict consistency with stored data. This architecture reduces the number of invalid or infeasible options, lowers error rates in recommendations, and provides a verifiable path from model output to resource usage control.

The server may, in other embodiments, employ different model architectures and training configurations. The server may use a recurrent neural network-based generative AI model or a hybrid model that combines rule-based modules with transformer-based modules. The server may adjust loss functions during training to penalize outputs that violate budget or inventory constraints, thereby further reducing the need for downstream correction. The server may use different feature sets, such as time-of-day features, user frequency features, and collaborative filtering embeddings, as additional inputs to the prompt sentence, so long as the processor maintains the essential function of integrating context, generating a prompt sentence, and structuring options from the model's output.

The terminal may, in some embodiments, execute part of the emotion estimation locally, for example using a compact neural network deployed on the terminal. In such embodiments, the terminal computes emotion information and transmits the emotion information to the server without transmitting raw image or audio data, thereby reducing communication load and improving privacy. The server then combines the locally-produced emotion information with centrally stored inventory and sales data to produce contextual information. This variation still maintains the core improvement to computer technology by distributing processing according to resource constraints and reducing network usage while preserving integrated context handling.

The system may be applied to various types of processing target resources and use cases. The server may manage physical commodities, digital content, or processing capacities, provided that the server maintains inventory and usage records and integrates them into the contextual information supplied to the generative AI model. The user may be an individual consumer, a system operator, or a programmatic client, provided that the terminal acquires user state information and spending plan information and that the server updates records accordingly. The essential technical characteristics are that the server integrates multi-modal inputs and internal operational context, generates a prompt sentence encoding such context for the generative AI model, structures the model's outputs into options, and uses the resulting request information to update and control resource records in a feedback loop.

The present invention is not limited to the above-described embodiments. The server may employ different storage schemas for inventory and sales information, different neural network architectures for emotion estimation and text generation, and different optimization strategies for prompt sentence generation. The terminal may be any electronic device capable of executing a client application and communicating with the server. The user interface may use voice, touch, or other interaction modalities. All such variations that do not depart from the core configuration of a processor configured to generate context-based prompt sentences for a generative AI model, to structure outputs into options, and to update resource records based on request information are included within the scope of the present invention.

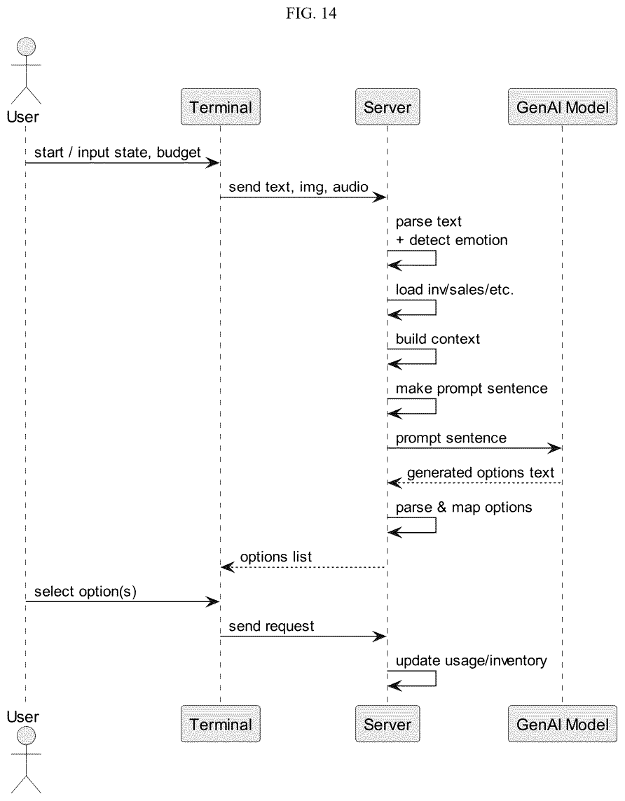

The following describes the processing flow using FIG. 14.

### Step 1:

Terminal displays an input interface and acquires user state information and user spending plan information.

Terminal receives, as input, a trigger indicating that a user has approached or seated, and initializes a graphical user interface on a display device. Terminal renders text fields, selection widgets, and buttons asking the user about mood, desired style, preferred item category, and budget amount. User provides, as input to the terminal, touch operations and optional voice utterances such as “I want something light and refreshing” or “My budget is 1,000 yen.” Terminal converts touch events into structured text strings and records raw audio from a microphone into an audio buffer. Terminal outputs a composite input packet containing textual user state information, numerical budget information, and raw audio data, encapsulated in a structured message.

### Step 2:

Terminal acquires image and audio data for emotion estimation and transmits user input information to the server.

Terminal receives, as input, a command from its client application to start sensing operations. Terminal activates a camera to capture one or more image frames of the user's face and activates a microphone to capture a short segment of ambient speech. Terminal compresses the image frames and audio samples using predetermined codecs and associates them with the textual user state and spending plan information collected in Step 1. Terminal outputs a network message including user identifier, seat identifier, text input, budget, compressed image frames, and compressed audio, and sends this message to the server via a secure communication channel.

### Step 3:

Server receives user input information and performs natural language parsing on textual data.

Server receives, as input, the network message from the terminal that includes raw text, budget value, and identifiers. Server stores this message in a temporary buffer and extracts the textual portion as well as numeric fields indicating budget or other constraints. Server applies a natural language processing module that tokenizes the text, assigns part-of-speech tags, and detects named entities such as currency amounts or item types. Server performs data processing by converting tokens into a feature vector and normalizing the budget into a standardized numerical field. Server outputs a structured representation of the user's textual request, including fields such as desired style, preferred category, and normalized budget, and stores this representation in working memory.

### Step 4:

Server executes emotion estimation based on image data and audio data.

Server receives, as input, compressed image frames and audio samples from the terminal along with the parsed text representation from Step 3. Server decodes the image frames and applies a face detection algorithm to locate a face region and derive facial landmarks such as eye and mouth positions. Server extracts acoustic features from the audio samples, including frequency-domain coefficients and energy measures. Server concatenates the visual feature vector and acoustic feature vector and inputs this combined vector to an emotion estimation model implemented as a neural network. Server computes, by forward propagation through the model layers, a probability distribution over emotion classes such as “happy,” “tired,” or “neutral.” Server outputs emotion information consisting of a primary emotion label and associated confidence scores, and stores this as part of the user state information.

### Step 5:

Server retrieves inventory information, sales information, procurement information, environmental information, and seasonal information from a data storage device.

Server receives, as input, a request context containing the structured user state information, emotion information, and a session identifier. Server generates database queries for multiple tables: an inventory table, a sales table, a procurement table, an environmental data source, and a seasonal mapping table. Server executes these queries, obtaining as raw output sets of records including item identifiers, current stock quantities, daily sales counts, procurement dates, environmental conditions such as temperature and weather, and seasonal flags. Server performs data processing by loading these records into memory-resident data structures and aligning them by item identifier and time frame. Server outputs an aggregated operational dataset that associates each candidate item with inventory level, sales performance, acquisition freshness, environmental suitability, and seasonal status.

### Step 6:

Server generates contextual information by integrating user state information with operational data.

Server receives, as input, the structured user state and emotion information from Steps 3 and 4 and the aggregated operational dataset from Step 5. Server computes, for each candidate item, a set of derived attributes such as match-to-mood score, budget-compatibility flag, overstock flag, low-sales flag, environmental match score, and seasonal match score. Server applies predefined weighting parameters to these attributes and calculates a composite context score for each item using a mathematical formula such as a weighted sum or non-linear function. Server outputs contextual information in the form of a list of candidate items, where each item is associated with measured attributes and a computed context score reflecting both user state and system state.

### Step 7:

Server selects candidate items based on contextual information and prepares key context elements for prompt construction.

Server receives, as input, the list of candidate items and their context scores from Step 6. Server filters out any items that violate hard constraints such as insufficient stock or exceeding the user's spending plan. Server sorts the remaining items by context score and identifies a subset of top-scoring items as primary candidates. Server extracts key elements such as identifiers of overstocked items, identifiers of underperforming items, and representative attributes corresponding to the user's mood, budget, and environmental condition. Server outputs a condensed context summary that is suitable for inclusion in a prompt sentence and stores this summary as part of the current interaction state.

### Step 8:

Server generates a prompt sentence encoding contextual information for a generative AI model.

Server receives, as input, the condensed context summary from Step 7, including user state, emotion, budget, lists of overstocked and underperforming items, and environmental conditions. Server accesses a template library stored in memory and selects a template corresponding to the application domain and type of recommendation. Server performs data processing by replacing placeholder tokens in the template with specific values from the context summary, thereby constructing a continuous natural-language text sequence. Server may, for example, insert the phrases “something light and refreshing,” “tired but relaxed,” “1,000 yen,” “salmon and cucumber,” and “hot and sunny” into appropriate positions in the template. Server outputs a prompt sentence that explicitly instructs the generative AI model to generate options constrained by the integrated context.

### Step 9:

Server supplies the prompt sentence to the generative AI model and obtains generated text describing options.

Server receives, as input, the prompt sentence created in Step 8. Server encodes the prompt sentence into a sequence of token identifiers compatible with the generative AI model and initializes model parameters such as maximum token length and sampling temperature. Server executes a forward-generation process in the model, successively computing output token probabilities at each decoding step based on internal attention mechanisms and previously generated tokens. Server applies a sampling or decoding strategy, such as top-k sampling or beam search, to select output tokens and assemble them into natural-language text describing a plurality of candidate options. Server outputs generated text that contains option names, brief explanations, and, optionally, indicative price information.

### Step 10:

Server parses generated text and structures the options into machine-usable records.

Server receives, as input, the generated text from the generative AI model along with the context summary from Step 7. Server applies pattern recognition rules and lexical analysis to split the text into individual option descriptions, detect item names, and extract descriptive phrases. Server executes a matching algorithm that aligns each generated option name with an item identifier stored in the inventory and sales data, based on string similarity metrics and mapping tables. Server constructs, for each matched option, a structured record containing an item identifier, a display name, a description, an estimated or known price, and metadata tags such as mood match and waste-reduction contribution. Server outputs a list of structured option records ready for presentation to the user.

### Step 11:

Server transmits structured options to the terminal for display, and terminal presents the options to the user.

Server receives, as input, the structured option records from Step 10 and the terminal identifier from the current session. Server assembles a response message including all structured options and transmits this message to the terminal. Terminal receives, as input, the response message from the server. Terminal parses the structured option records, loads any associated images or icons from local storage or server-side resources, and renders a graphical list on the display. Terminal arranges the options with names, descriptions, and prices, and may annotate options with labels such as “recommended for your current mood” or “helps reduce waste.” Terminal outputs a fully rendered options screen for user interaction.

### Step 12:

User selects one or more options, and terminal generates request information for the server.

User receives, as input, the displayed options list on the terminal screen. User performs a selection operation by touching desired options and specifying quantities through graphical controls. Terminal captures these touch events and updates internal selection data in real time. When the user confirms the choice, terminal compiles the selection data into request information that includes selected item identifiers, quantities, the associated session or seat identifier, and a timestamp. Terminal outputs a request message that encapsulates the user's selection and sends this message to the server.

### Step 13:

Server processes request information and updates usage records and inventory records.

Server receives, as input, the request message from the terminal containing selected item identifiers and quantities. Server validates the request against current inventory and user constraints, and then updates a usage record by appending a transaction entry that logs the requested items and their quantities. Server reduces the corresponding stock quantities in the inventory records and increments the sales counts in the sales records, performing arithmetic operations on stored numerical fields. Server outputs updated inventory and sales datasets and stores them back into the data storage device.

### Step 14:

Server reflects updated records into subsequent contextual information and prompt generation.

Server receives, as input, the updated inventory records, updated sales records, and the previous context used in the current interaction. Server recalculates derived attributes such as overstock flags and low-sales flags for affected items, and updates composite context scores where necessary. Server stores these updated attributes for use in future interactions with the same or other users. Server outputs a refreshed internal state such that, during a next invocation of Steps 5 through 8, the contextual information and prompt sentence will be formed using the latest usage and inventory data, thereby closing the feedback loop and improving recommendation accuracy and system efficiency over time.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

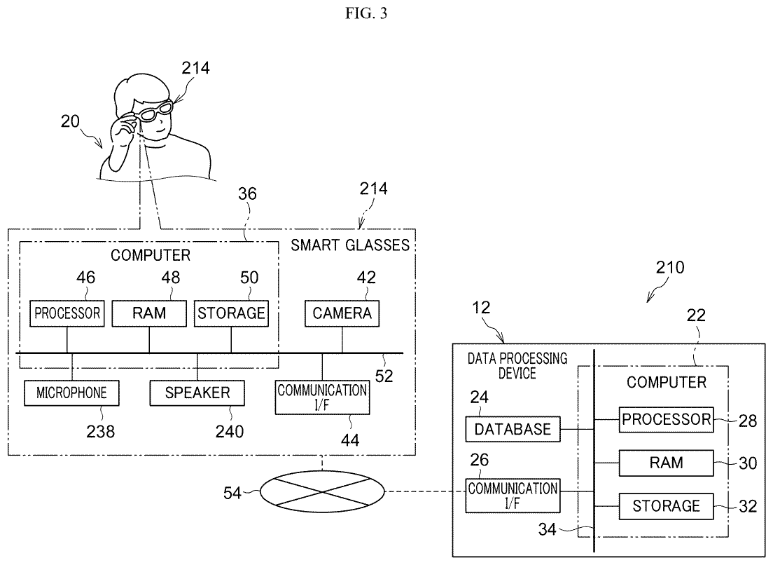

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

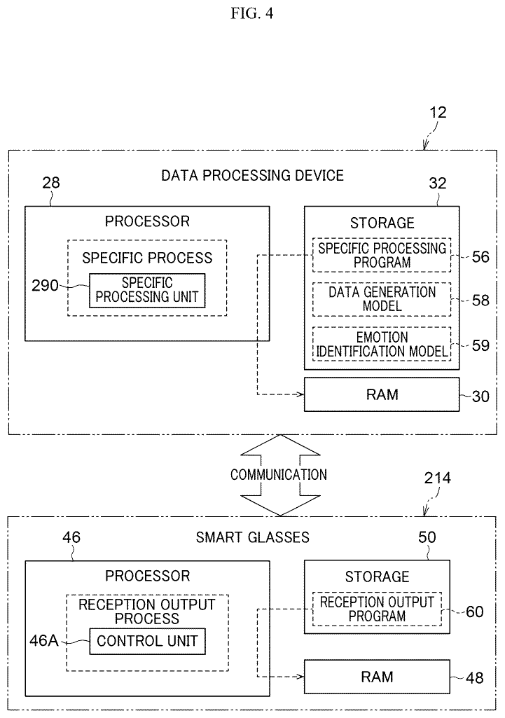

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

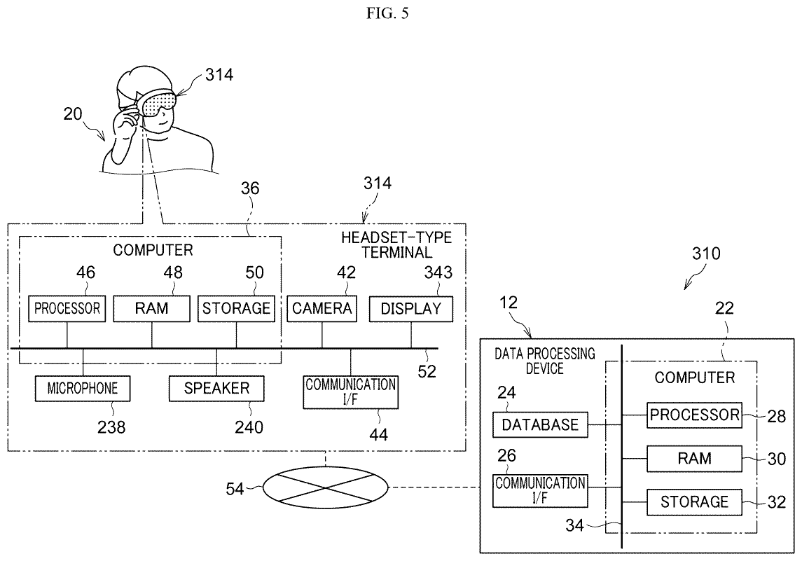

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

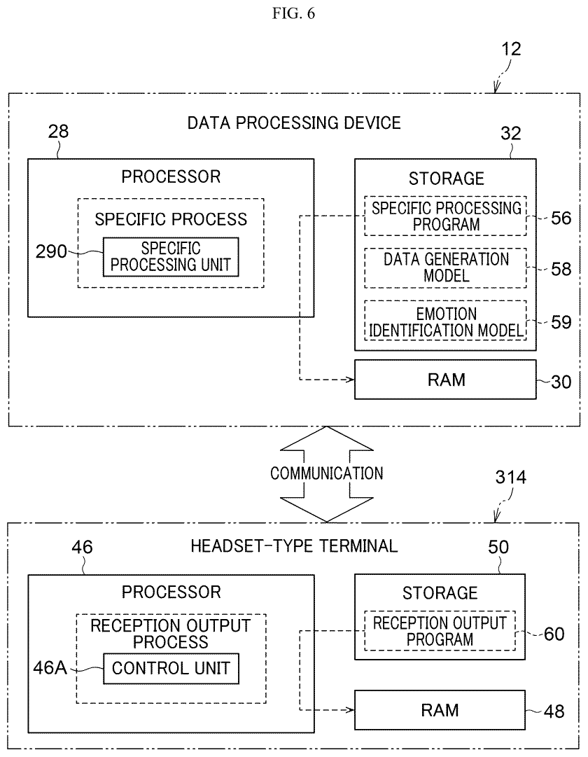

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

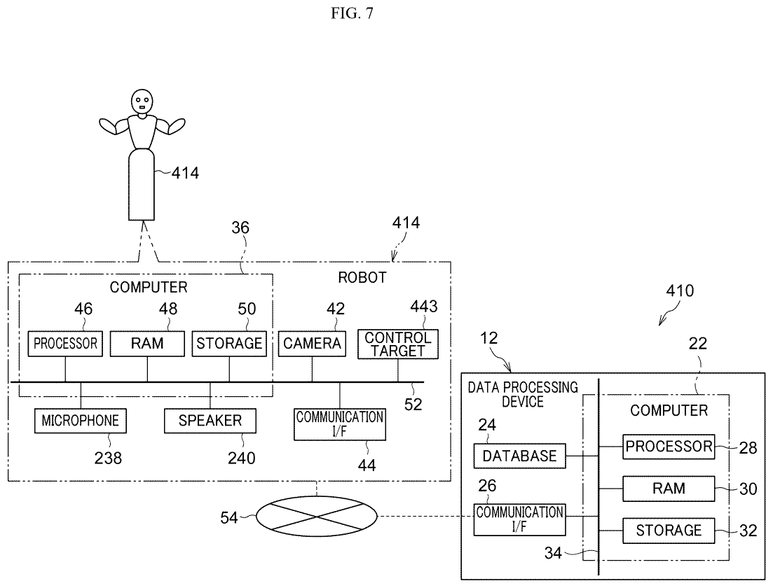

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

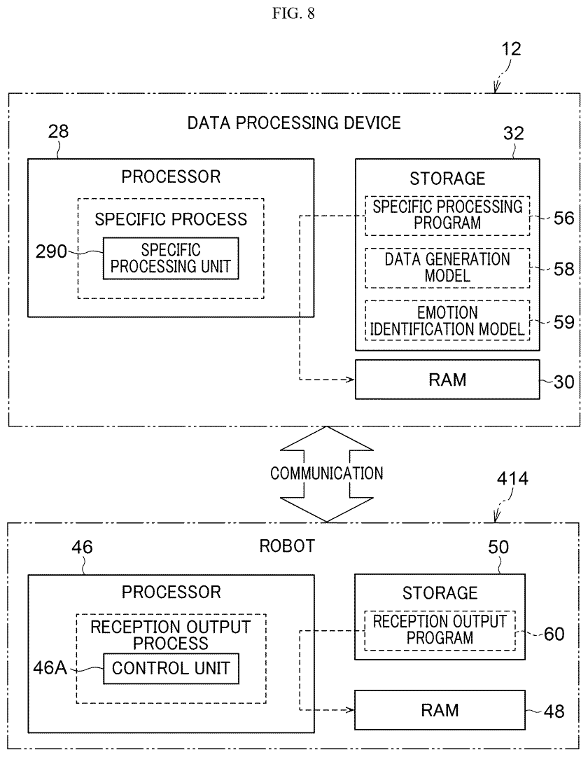

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

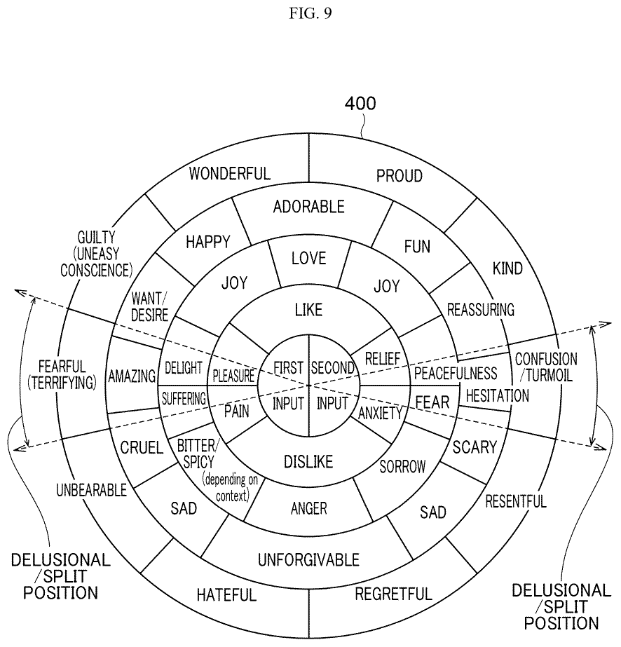

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

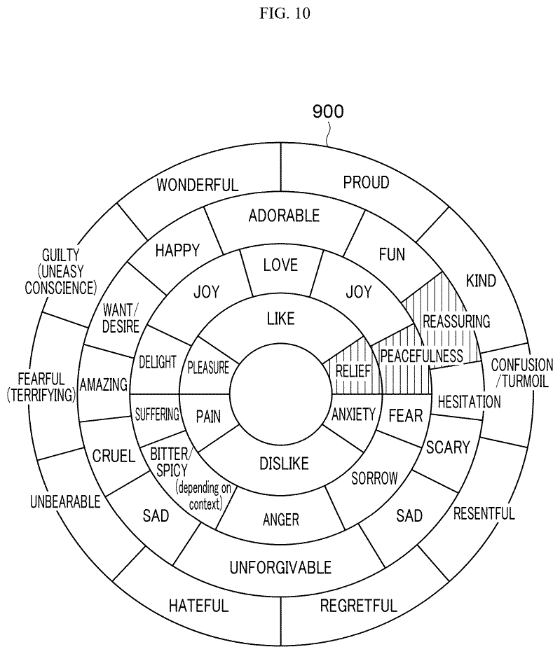

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### EXAMPLE 1

### (Supplementary 1)

A system comprising a processor, a memory device, a display device, an input device, a communication device, and a detection device,
wherein the processor is configured to
receive a detection signal from the detection device provided at a seat, determine that a user has taken the seat based on the detection signal, and automatically activate an information processing device in response to the determination, and control a user interface including the display device and the input device,
acquire user preference information and user expenditure plan information via the user interface, acquire item information from the memory device or from an external device that manages the item information via the communication device, generate a prompt sentence to be input to a generative AI model based on the user preference information, the user expenditure plan information, and the item information, input the prompt sentence and the item information to the generative AI model, and obtain, from the generative AI model, option information including a plurality of options corresponding to the user preference information and the user expenditure plan information,
control the display device to present the option information to the user and, based on one or more options selected by the user via the input device, generate order information corresponding to the selected one or more options, and transmit the order information to an external processing device via the communication device, and
acquire availability information or supply information from the external processing device via the communication device, update the option information obtained from the generative AI model based on the availability information or the supply information, and cause the display device to re-display the updated option information to the user.

### (Supplementary 2)

The system according to supplementary 1,
wherein the processor is configured to, in response to detection of seating of the user by the detection device, activate the information processing device, invoke the generative AI model, generate an initial prompt sentence for inquiring about meal content and an expenditure plan of the user, and control the display device to display the initial prompt sentence via the user interface.

### (Supplementary 3)

The system according to supplementary 1,
wherein the processor is configured to acquire past order history information and past response history information of the user or of the seat from the memory device, include the past order history information and the past response history information in the prompt sentence to be input to the generative AI model, and thereby cause the generative AI model to generate option information based on the past order history information and the past response history information so as to present order candidates that improve efficiency of resource utilization.

### Application Example 1

### (Supplementary 1)

A system comprising a processor,
wherein the processor is configured to
detect a seating state of a user by using a detection unit, and
acquire user information including a condition of the user and a spending plan of the user by using a user information acquisition unit, and
acquire resource inventory information and transaction history information from a storage unit, and
generate a prompt sentence to be input to a generative AI model, the prompt sentence being generated on the basis of the user information, the resource inventory information, and the transaction history information by using a prompt generation unit, and
input the prompt sentence to the generative AI model and receive response information from the generative AI model, and analyze the response information to generate candidate information by using a candidate generation unit, and
transmit the candidate information to a user information terminal and control the user information terminal to display the candidate information and to accept a selection operation by using a presentation control unit, and
acquire a selection result from the user information terminal, generate order information on the basis of the selection result, and update the resource inventory information in accordance with the order information by using a resource management unit.

### (Supplementary 2)

The system according to supplementary 1,
wherein the processor is configured to
control the detection unit to automatically start an information processing apparatus in response to detection of the seating state, and
control the user information acquisition unit to provide, on a display screen of the information processing apparatus, an input interface for the condition of the user and the spending plan of the user, and
control the prompt generation unit to generate the prompt sentence on the basis of the user information acquired through the input interface.

### (Supplementary 3)

The system according to supplementary 1,
wherein the processor is configured to
control the prompt generation unit to refer to the resource inventory information and the transaction history information and to add, to the prompt sentence, a directive to cause the generative AI model to preferentially include resources having a high risk of disposal in generation of the candidate information, and
control the candidate generation unit to extract, from the response information received from the generative AI model, only candidate information that conforms to the resource inventory information and the spending plan of the user, and to output the extracted candidate information to the presentation control unit.

### EXAMPLE 2

### (Supplementary 1)

A system comprising a processor,
wherein the processor is configured to
acquire user-related information via a user information input/output apparatus, the user-related information including at least information regarding a user's desired items and an upper limit of expenditure,
obtain, on the basis of the user-related information, supply status information, sales performance information, inventory information, season-related merchandise information, and weather-related information from an information storage apparatus that stores such information,
generate, by using the user-related information and the obtained supply status information, sales performance information, inventory information, season-related merchandise information, and weather-related information, a prompt sentence including condition information for specifying options suitable for the user-related information and output format information,
input the generated prompt sentence into a generative AI model and acquire candidate option information generated by the generative AI model based on the prompt sentence,
verify product information included in the candidate option information by comparing the product information with the inventory information and the information regarding the upper limit of expenditure, and generate final option information that satisfies budget constraints and resource utilization efficiency based on a verification result, and
output the final option information to the user information input/output apparatus to present the final option information to the user.

### (Supplementary 2)

The system according to supplementary 1,
wherein the processor is configured to
control activation of an information processing apparatus based on detection information obtained from a detection apparatus that detects a seating state of the user at the user information input/output apparatus, thereby automatically activating the information processing apparatus when the user is seated,
control generation of the prompt sentence such that, after the automatic activation, the prompt sentence causes the generative AI model to generate user guidance information that prompts input of the user-related information, and
cause an initial presentation screen to be promptly displayed on the user information input/output apparatus based on the user guidance information output from the generative AI model.

### (Supplementary 3)

The system according to supplementary 1,
wherein the processor is configured to
refer to past usage history information and resource consumption history information as at least part of the supply status information, the sales performance information, and the inventory information,
generate the prompt sentence including condition information that instructs the generative AI model to generate options that promote efficient resource utilization and waste reduction by using the past usage history information and the resource consumption history information, and
input the generated prompt sentence into the generative AI model so that the generative AI model outputs option information reflecting the efficient resource utilization and the waste reduction.

### Application Example 2

### (Supplementary 1)

A system comprising a processor,
wherein the processor is configured to
provide an interface for acquiring user state information and user spending plan information, analyze user input information acquired through the interface to estimate a user state including emotion information,
acquire inventory information, sales information, procurement information, environmental information, and seasonal information from a data storage device and generate contextual information by integrating the contextual information with the user state,
generate a prompt sentence, based on the contextual information, for instructing a generative artificial intelligence model to present optimal options in consideration of efficient resource utilization and reduction of waste,
input the prompt sentence to the generative artificial intelligence model and analyze output information obtained from the generative artificial intelligence model to structure the options, output the structured options to a display device to present the structured options to the user and generate request information in response to a selection operation by the user or an automatic decision based on the emotion information, and
update a usage record and an inventory record of a processing target resource based on the request information and reflect an updated result in subsequent generation of the prompt sentence and in subsequent presentation of the options.

### (Supplementary 2)

The system according to supplementary 1,
wherein the processor is configured to
control an information processing device to be automatically activated by using a detection unit that detects seating of the user, and to activate the interface, an imaging device, and an audio acquisition device by the information processing device so as to immediately acquire the user state and the emotion information.

### (Supplementary 3)

The system according to supplementary 1,
wherein the processor is configured to
analyze past inventory information, past sales information, and a past user state history, calculate priority information for performing efficient resource utilization and sales promotion based on an analysis result, include the priority information in the contextual information, and generate the prompt sentence so that the priority information is reflected in generation of the options by the generative artificial intelligence model.

What is claimed is:

1. A system comprising:
circuitry configured to:
receive, from a terminal apparatus via a packet-switched network, entity state information and expenditure constraint information;
acquire resource item data from a storage medium, the resource item data including item identifiers, attribute values, quantity values, and availability indicators;
construct a parameterized instruction sequence based on the entity state information, the expenditure constraint information, and the resource item data, the parameterized instruction sequence specifying a candidate generation task for a generative neural network model;
provide the parameterized instruction sequence to the generative neural network model to cause the generative neural network model to generate candidate option data comprising a plurality of candidate resource item combinations; and
verify the candidate option data against the resource item data and the expenditure constraint information to generate validated option data satisfying resource availability conditions and expenditure constraint conditions, and transmit the validated option data to the terminal apparatus via the packet-switched network.

2. The system according to claim 1, wherein the circuitry is further configured to:
receive a detection signal from a sensor device associated with a designated position, determine an occupancy state of the designated position based on the detection signal by comparing a sampled signal value against a threshold value over a predetermined debounce period, and automatically activate the terminal apparatus in response to determining that the designated position is occupied.

3. The system according to claim 2, wherein the sensor device comprises at least one of a pressure sensor, a proximity sensor, and an optical sensor, and wherein the circuitry samples the detection signal at fixed intervals, averages a plurality of samples to reduce noise, and determines the occupancy state based on the averaged value exceeding the threshold value continuously for the predetermined debounce period.

4. The system according to claim 3, wherein the circuitry is further configured to:
upon activation of the terminal apparatus, construct an initial parameterized instruction sequence instructing the generative neural network model to generate guidance data for prompting acquisition of the entity state information and the expenditure constraint information, and transmit the guidance data to the terminal apparatus for display on a presentation interface.

5. The system according to claim 1, wherein the circuitry is further configured to:
acquire historical transaction data and historical response data associated with the entity or with the designated position from the storage medium, and incorporate the historical transaction data and the historical response data into the parameterized instruction sequence to cause the generative neural network model to generate candidate option data that reflects historical patterns.

6. The system according to claim 5, wherein the circuitry is further configured to:
extract from the historical transaction data statistical features including transaction frequency values, mean expenditure values, and item category distribution values, and include the statistical features in the parameterized instruction sequence as context data to constrain the candidate generation task.

7. The system according to claim 1, wherein the circuitry is further configured to:
acquire supply status data, sales performance data, and environmental condition data from the storage medium, compute aggregate metrics including stock level categories, sales frequency categories, and environmental suitability indicators for each resource item, and incorporate the aggregate metrics into the parameterized instruction sequence.

8. The system according to claim 7, wherein the parameterized instruction sequence includes a resource utilization directive instructing the generative neural network model to preferentially include resource items having quantity values exceeding a surplus threshold and sales frequency values below a demand threshold in the candidate option data, thereby promoting efficient resource consumption.

9. The system according to claim 8, wherein the circuitry is further configured to:
parse the candidate option data generated by the generative neural network model to extract item identifiers, quantity specifications, and price indicators, match the extracted item identifiers against item identifiers in the resource item data, and discard candidate resource item combinations that reference unavailable items or that have aggregate price values exceeding the expenditure constraint information.

10. The system according to claim 9, wherein the circuitry is further configured to:
compute a suitability score for each remaining candidate resource item combination based on a weighted scoring function that incorporates stock surplus level, sales frequency, price alignment with the expenditure constraint information, and alignment with the entity state information, and rank the candidate resource item combinations by the suitability score to generate the validated option data.

11. The system according to claim 10, wherein the circuitry is further configured to:
transmit the validated option data to the terminal apparatus, receive selection data from the terminal apparatus identifying one or more selected resource item combinations, generate transaction data based on the selection data, and update the resource item data in the storage medium by decrementing quantity values for resource items included in the transaction data.

12. The system according to claim 11, wherein the circuitry is further configured to:
reflect the updated resource item data in subsequent construction of the parameterized instruction sequence such that subsequent candidate option data generated by the generative neural network model accounts for current resource availability conditions.

13. The system according to claim 1, wherein the generative neural network model comprises a transformer-based architecture including an embedding layer, a plurality of self-attention layers, feed-forward layers, and normalization layers, and wherein the circuitry provides the parameterized instruction sequence as a token sequence to the transformer-based architecture together with decoding control parameters including a maximum output token count and a sampling temperature value.

14. The system according to claim 13, wherein the circuitry is further configured to:
acquire image data from an imaging device and acoustic data from an acoustic transducer associated with the terminal apparatus, extract visual feature data from the image data using a convolutional neural network, extract acoustic feature data from the acoustic data, concatenate the visual feature data and the acoustic feature data into a combined feature vector, and apply an emotion estimation model to the combined feature vector to compute emotion classification data.

15. The system according to claim 14, wherein the emotion estimation model comprises a multi-layer neural network having an input layer corresponding to dimensions of the combined feature vector, one or more hidden layers with non-linear activation functions, and an output layer that computes probability distributions over a set of emotion category labels.

16. The system according to claim 15, wherein the circuitry is further configured to:
incorporate the emotion classification data into the parameterized instruction sequence as additional context data to cause the generative neural network model to generate candidate option data tailored to the estimated emotional state of the entity.

17. The system according to claim 16, wherein the circuitry is further configured to:
store the emotion classification data as part of an entity state history in the storage medium, and compute priority data for resource items based on at least the entity state history, the historical transaction data, and the resource item data, and include the priority data in the parameterized instruction sequence to influence resource item selection by the generative neural network model.

18. A system comprising:
circuitry configured to:
receive, via a communication interface coupled to a packet-switched network, entity state information and expenditure constraint information from a terminal apparatus;
acquire resource item data including item identifiers, quantity values, and availability indicators, and historical transaction data from a storage medium;
construct a parameterized instruction sequence based on the entity state information, the expenditure constraint information, the resource item data, and the historical transaction data, the parameterized instruction sequence including a resource utilization directive;
provide the parameterized instruction sequence to a generative neural network model having a transformer-based architecture including a plurality of self-attention layers to generate candidate option data;
verify the candidate option data against the resource item data and the expenditure constraint information to generate validated option data, and compute suitability scores for the validated option data based on resource surplus levels and expenditure alignment; and
transmit the validated option data to the terminal apparatus, receive selection data, generate transaction data, and update the resource item data in the storage medium based on the transaction data.

19. The system according to claim 18, wherein the circuitry is further configured to:
acquire image data and acoustic data associated with the entity from the terminal apparatus, apply an emotion estimation model comprising a multi-layer neural network to a combined feature vector derived from the image data and the acoustic data to compute emotion classification data, and incorporate the emotion classification data into the parameterized instruction sequence to cause the generative neural network model to generate candidate option data reflecting the estimated emotional state.

20. A method performed by circuitry, the method comprising:
receiving, from a terminal apparatus via a packet-switched network, entity state information and expenditure constraint information;
acquiring resource item data from a storage medium, the resource item data including item identifiers, attribute values, quantity values, and availability indicators;
constructing a parameterized instruction sequence based on the entity state information, the expenditure constraint information, and the resource item data, the parameterized instruction sequence specifying a candidate generation task for a generative neural network model;
providing the parameterized instruction sequence to the generative neural network model to cause the generative neural network model to generate candidate option data comprising a plurality of candidate resource item combinations; and
verifying the candidate option data against the resource item data and the expenditure constraint information to generate validated option data satisfying resource availability conditions and expenditure constraint conditions, and transmitting the validated option data to the terminal apparatus via the packet-switched network.
